(19) United States
(12) Patent Application Publication
(10) Pub. No.: US 2008/0242794 A1
(43) Pub. Date: Oct. 2, 2008

(54) COLOR STABILIZED ANTIMICROBIAL POLYMER COMPOSITES

(76) Inventors: David W. Sandford, Rochester, NY (US); Thomas N. Blanton, Rochester, NY (US)

Correspondence Address: Andrew J. Anderson;Patent Legal Staff, Eastman Kodak Company, 343 State Street, Rochester, NY, 14650-2201, US

(21) Appl. No.: 11/694,390

(22) Filed: Mar. 30, 2007

(51) Int. Cl. C08K 3/16; C08K 5/36; C08L 31/08

(52) U.S. Cl. 524/515; 524/543; 524/550; 524/556; 524/559

(57) ABSTRACT

A polymer composite comprising a melt-processed polymer compounded with a color stabilizer comprising a bromate or iodate ion, and a silver-based antimicrobial agent. The specified color stabilizers are particularly superior in inhibiting undesirable darkening or discoloration of melt-processed polymers compounded with silver-based antimicrobial agents containing a grain-size controlling additive.

### CROSS REFERENCE TO RELATED APPLICATIONS

Reference is made to commonly assigned, concurrently-filed, copending U.S. Ser. No. ______ (Kodak Docket 93821) directed towards “Production of Silver Sulfate Grains Having Inorganic Additives”, the disclosure of which is incorporated by reference herein.

### FIELD OF THE INVENTION

The present invention relates to improvements in color of melt-processed polymer composites and plastic objects made there of, within which a silver-based antimicrobial agent containing a grain-size controlling additive has been introduced. More particularly, the invention is directed towards use of specific color stabilizers in such polymer composites, and a preferred method of introducing the color stabilizers and silver-based antimicrobial agents to a melt-processed polymer.

### BACKGROUND OF THE INVENTION

Widespread attention has been focused in recent years on the consequences of bacterial contamination contracted by food consumption or contact with common surfaces and objects. Some noteworthy examples include the sometimes fatal outcome from food poisoning due to the presence of particular strains of Eschericia coli in undercooked beef; Salmonella contamination in undercooked and unwashed poultry food products; as well as illnesses and skin irritations due to Staphylococcus aureus and other micro-organisms. Anthrax is an acute infectious disease caused by the spore-forming bacterium bacillus anthracis. Allergic reactions to molds (e.g. Aspergillus niger) and yeasts (e.g. Candida albicans) are a major concern to many consumers and insurance companies alike. Human immunodeficiency virus (HIV) is a retrovirus that causes acquired immunodeficiency syndrome (AIDS), a condition that has reached pandemic proportions as the World Health Organization estimates it is responsible for over 25 million deaths. Other viruses, such as the Ebola, Marburg, Hepatitus A, B, C, D, E and various Influenza, are highly contagious and deadly diseases with the theoretical potential to become pandemics. Respiratory infections due to viruses such as the severe acute respiratory syndrome (SARS) coronavirus, and the return of the H5N1 virus and mutations thereof, now commonly referred to as the avian flu or bird flu, which was responsible for the great pandemic influenza of 1918, have become major public health issues. In addition, significant fear has arisen in regard to the development antibiotic-resistant strains of bacteria, such as methicillin-resistant Staphylococcus aureus (MRSA) and vancomycin-resistant Enterococcus (VRE). The Centers for Disease Control and Prevention estimates that 10% of patients contract additional diseases during their hospital stay and that the total deaths resulting from these nosocomially-contracted illnesses exceeds those suffered from vehicular traffic accidents and homicides. In response to these concerns, manufacturers have begun incorporating antimicrobial agents into materials used to produce objects for commercial, institutional and residential use.

The antimicrobial properties of silver have been known for several thousand years. The general pharmacological properties of silver are summarized in “Heavy Metals” and “Antiseptics and Disinfectants: Fungicides; Ectoparasiticides”—by Stewart C. Harvey in The Pharmacological Basis of Therapeutics, Fifth Edition, by Louis S. Goodman and Alfred Gilman (editors), published by MacMillan Publishing Company, NY, 1975. It is now understood that the affinity of silver ion for biologically important moieties such as sulfhydryl, amino, imidazole, carboxyl and phosphate groups are primarily responsible for its antimicrobial activity.

The attachment of silver ions to one of these reactive groups on a protein results in the precipitation and denaturation of the protein. The extent of the reaction is related to the concentration of silver ions. The diffusion of silver ion into mammalian tissues is self-regulated by its intrinsic preference for binding to proteins through the various biologically important moieties on the proteins, as well as precipitation by the chloride ions in the environment. Thus, the very affinity of silver ion to a large number of biologically important chemical moieties (an affinity which is responsible for its action as a germicidal/biocidal/viricidal/fungicidal/bacteriocidal agent) is also responsible for limiting its systemic action—silver is not easily absorbed by the body. This is a primary reason for the tremendous interest in the use of silver containing species as an antimicrobial i.e. an agent capable of destroying or inhibiting the growth of microorganisms, including bacteria, yeast, fungi and algae, as well as viruses.

In addition to the affinity of silver ions for biologically relevant species, which leads to the denaturation and precipitation of proteins, some silver compounds, those having low ionization or dissolution ability, also function effectively as antiseptics. Distilled water in contact with metallic silver becomes antibacterial even though the dissolved concentration of silver ions is less than 100 ppb. There are numerous mechanistic pathways by which this oligodynamic effect is manifested i.e. by which silver ion interferes with the basic metabolic activities of bacteria at the cellular level, thus leading to a bacteriocidal and/or bacteriostatic effect.

A detailed review of the oligodynamic effect of silver can be found in “Oligodynamic Metals” by I. B. Romans in Disinfection, Sterilization and Preservation, C. A. Lawrence and S. S. Bloek (editors), published by Lea and Fibiger (1968) and “The Oligodynamic Effect of Silver” by A. Goetz, R. L. Tracy and F. S. Harris, Jr. in Silver in Industry, Lawrence Addicks (editor), published by Reinhold Publishing Corporation, 1940. These reviews describe results that demonstrate that silver is effective as an antimicrobial agent towards a wide range of bacteria.

While it is well known that silver-based agents provide excellent antimicrobial properties, aesthetic problems due to discoloration are frequently a concern. This is believed to be due to several root causes, including the inherent thermal and photo-instability of silver ions, along with other mechanisms. A wide range of silver salts are known to be thermally and photolytically unstable, discoloring to form brown, gray or black products. Silver ion may be formally reduced to its metallic state, assuming various physical forms and shapes (particles and filaments), often appearing brown, gray or black in color. Reduced forms of silver that form particles of sizes on the order of the wavelength of visible light may also appear to be pink, orange, yellow, beige and the like due to light scattering effects. Alternatively, silver ion may be formally oxidized to silver peroxide, a gray-black material. In addition, silver ion may simply complex with environmental agents (e.g. grain size controlling agents, polymer additives, catalyst residues, impurities, surface coatings, etc.) to form colored species without undergoing a formal redox process. Silver ion may attach to various groups on proteins present in human skin, resulting in the potentially permanent dark stain condition known as argyria. Silver ion may react with sulfur to form silver sulfide, for which two natural mineral forms, acanthite and argentite, are known to be black in color. Pure silver sulfate (white in color) has been observed to decompose by light to a violet color.

In any given practical situation, a number of mechanisms or root causes may be at work in generating silver-based discoloration, complicating the task of providing a solution to the problem. For example, Coloplast, as describe in U.S. Pat. No. 6,468,521 and U.S. Pat. No. 6,726,791, disclose the development of a stabilized wound dressing having antibacterial, antiviral and/or antifungal activity characterized in that it comprises silver complexed with a specific amine and is associated with one or more hydrophilic polymers, such that it is stable during radiation sterilization and retains the activity without giving rise to darkening or discoloration of the dressing during storage. Registered as CONTREET™, the dressing product comprises a silver compound complexed specifically with either ethylamine or tri-hydroxymethyl-aminomethane. These specific silver compounds, when used in conjunction with the specific polymer binders carboxymethylcellulose or porcine collagen, are said to have improved resistance to discoloration when exposed to heat, light or radiation sterilization and contact with skin or tissue.

The point in time when discoloration of a composition associated with a silver-based additive appears can range from early in the manufacturing process to late in a finished article's useful life. For example, thermal instability can set in shortly after introduction of the silver-based additive into a high temperature melt-processed polymer, or much later during long-term storage of the material or finished article at lower (e.g. ambient) temperatures, sometimes referred to as long-term heat stability (LTHS). Likewise, photo-instability can result from short-term exposure to high-energy radiation processing or radiation sterilization, or later from long-term exposure of the material or finished article to ambient light (e.g. requiring ultraviolet (UV) stabilization). In addition, polymeric materials are well known to inherently discolor to some degree either during high temperature melt processing, or later due to aging in the presence of light, oxygen and heat.

Thermoplastic polymers such as polyolefins are typically processed at temperatures between about 200-280° C. and will degrade under these conditions by an oxidative chain reaction process that is initiated by free-radical formation. Free radicals (R*) formed either along the polymer backbone or at terminal positions will react quickly with oxygen (O₂) to form peroxy radicals (ROO*), which in turn can react with the polymer to form hydroperoxides (ROOH) and another free radical (R*). The hydroperoxide can then split into two new free radicals, (RO*) and (*OH), which will continue to propagate the reaction to other polymer chains. It is well known in the art that antioxidants and light stabilizers can prevent or at least reduce the effects of these oxidative chain reactions. Several types of additives are added to polymers to protect them during processing and to achieve the desired end-use properties. Additives are generally divided into groups: stabilizers and modifiers. Typical modifiers are antistatic- and antifogging agents, acid scavengers, blowing agents, cling agents, lubricants and resins, nucleating agents, slip- and anti-blocking agents as well as fillers, flame retardants, compatibilizers and crosslinkers. Antioxidant stabilizers are typically classified as (1) free-radical scavengers or primary antioxidants, and (2) hydroperoxide decomposers or secondary antioxidants.

Primary antioxidants are added to polymers mainly to improve long-term heat stability of the final fabricated article. Primary antioxidants are often called free radical scavengers because they are capable of reacting quickly with peroxy or other available free radicals to yield an inert or much less reactive free radical species, thus halting or slowing down the oxidative chain reaction process that leads to degradation. Primary antioxidants typically include, for instance, sterically hindered phenols, secondary aromatic amines, hydroquinones, p-phenylenediamines, quinolines, hydroxytriazines or ascorbic acid (vitamin C). Although aromatic amines are the strongest primary antioxidant, they are highly staining and seldom used in thermoplastics. Sterically hindered phenols are diverse in number as well as commercially available in high purity. Hindered phenols have been structurally classified as (1) alkylphenols, (2) alkylidine-bisphenols, (3) thiobisphenols, (4) hydroxybenzyl compounds, (5) acylaminophenols, and (6) hydroxyphenyl propionates.

Secondary antioxidants are added to polymers mainly to provide needed short-term stability in melt flow and color during high temperature melt processing of the plastic material. They are believed to function by reacting with hydroperoxides to yield stable products that are less likely to fragment into radical species. Secondary antioxidants can usually be classified chemically as either a phosphorous-containing or a sulfur-containing compound. Phosphites such as triesters of phosphoric acid (P(OR′)₃) are believed to react with hydroperoxides (ROOH) to form phosphates (OP(OR′)₃) and alcohols (ROH). Elemental sulfur compounds and diaryl disulfides are reported to decompose hydroperoxides by generating sulfur dioxide. Thioethers (R₁SR₂) are believed to react with hydroperoxides (ROOH) to yield sulfoxides (R₁SOR₂) and alcohols (ROH). Sulfoxides may in turn destroy several equivalents of hydroperoxide through the intermediate formation of sulfenic acids and sulfur dioxide.

A third group of antioxidant stabilizers is commonly referred to as synergists. These materials may not be effective stabilizers when used alone, but when used in combination with another antioxidant a cooperative action results wherein the total effect is greater than the sum of the individual effects taken independently. While not being held to any particular microscopic theory, the mechanism of antioxidants is described in “Rubber Chemistry and Technology” 47 (1974), No. 4, pages 988 and 989.

A conventional preferred antioxidant stabilizer combination known in the art to reduce discoloration in melt-processed polyolefins, and polypropylene in particular, includes a sterically hindered phenolic primary antioxidant with an organic phosphite or phosphonite secondary antioxidant, as disclosed, for instance in U.S. Pat. No. 6,015,854, U.S. Pat. No. 6,022,946, U.S. Pat. No. 6,197,886, U.S. Pat. No. 6,770,693, and U.S. Pat. No. 6,881,744. More recently, Sandford and Blanton (U.S. patent application Ser. No. 11/669,830 filed Jan. 31, 2007) have disclosed a preferred combination of antioxidants for polymer composites containing a silver-based antimicrobial agent, comprising a phenolic antioxidant and an organo-disulfide antioxidant.

A rapidly emerging application for silver based antimicrobial agents is inclusion in polymers used in plastics and synthetic fibers. A variety of methods is known in the art to render antimicrobial properties to a target fiber. The approach of embedding inorganic antimicrobial agents, such as zeolite, into low melting components of a conjugated fiber is described in U.S. Pat. No. 4,525,410 and U.S. Pat. No. 5,064,599. In another approach, the antimicrobial agent may be delivered during the process of making a synthetic fiber such as those described in U.S. Pat. No. 5,180,402, U.S. Pat. No. 5,880,044, and U.S. Pat. No. 5,888,526, or via a melt extrusion process as described in U.S. Pat. No. 6,479,144 and U.S. Pat. No. 6,585,843. Alternatively, deposition of antimicrobial metals or metal-containing compounds onto a resin film or target fiber has also been described in U.S. Pat. No. 6,274,519 and U.S. Pat. No. 6,436,420.

In addition to the color instabilities inherent to silver and to polymeric materials themselves, silver ion imbedded in polymer composites may react with polymer decomposition products (e.g. free radicals, peroxides, hydroperoxides, alcohols, hydrogen atoms and water), modifiers (e.g. chlorinated flame retardants), stabilizers and residual addenda (e.g. titanium tetrachloride, titanium trichloride, trialkylaluminum compounds and the like from Ziegler-Natta catalysts) to form potentially colored byproducts. More particularly, silver ion imbedded in polymer composites may react with grain-size controlling additives and decomposition products formed thereof. Thus the complexity of potential chemical interactions further challenges the modern worker in designing an effective stabilizer for polymers containing silver species.

A number of approaches have been taken in the past to reduce discoloration resulting from the inclusion of silver-based compounds in melt-processed polymers. Niira et al in U.S. Pat. No. 4,938,955 disclose melt-processed antimicrobial resin compositions comprising a silver containing zeolite and a single stabilizer (discoloration inhibiting agent) selected from the group consisting of a hindered amine (CHIMASSORB™ 944LD or TINUVIN™ 622LD), a benzotriazole, a hydrazine, or a hindered phenol (specifically octadecyl 3-(3,5-di-tert-butyl-4-hydroxyphenyl)propionate, commercially available as IRGANOX™ 1076). Reduction in long-term discoloration from exposure to 60 days of sunlight in the air was the only response reported.

Ohsumi et al in U.S. Pat. No. 5,405,644 disclose two fiber treatment processes in which the addition of a benzotriazole, preferably methylbenzotriazole, to treatment solutions subsequently inhibits discoloration in fibers comprising a silver containing tetravalent-metal phosphate antimicrobial agent. More specifically, addition of a benzotriazole to an ester spinning oil reduces discoloration in treated fibers following one day exposure to outdoor sunlight; and secondly, the addition of a benzotriazole to an alkali treatment solution reduces discoloration in treated fibers when examined immediately following treatment. It is suggested that the benzotriazole either retards the dissolution of silver ions or inhibits the reaction of small amounts of soluble silver ion with the various chemicals present in the fiber treatment solutions.

Lever in U.S. Pat. No. 6,187,456 discloses reduced yellowing of melt-processed polyolefins containing silver-based antimicrobial agents silver zirconium phosphate or silver zeolite when sodium stearate is replaced with aluminum magnesium hydrotalcite. Tomioka et al in JP08026921 disclose that discoloration from high temperature can be prevented for polypropylene compounded with a silver mixture containing specific amounts of sulfite and thiosulfate ion, if the antimicrobial silver mixture is impregnated on silica gel support. Dispersing silver-based antimicrobial agents into a wax or low molecular weight polymer as a carrier that is intern blended into a higher molecular weight polymer is disclosed in JP03271208A and JP2841115B2 as a safe means to handle higher concentrations of silver-based antimicrobial agents without staining the skin.

Some workers report reducing discoloration by simply combining silver-based antimicrobial agents with other antimicrobial agents in hopes of reducing the total amount of silver in a given formulation. Ota et al in JP04114038 combine silver sulfate with the organic antifungal agent TBZ (2-(4-thiazolyl)benzimidazole) to reduce discoloration in injection molded polypropylene. Herbst in U.S. Pat. No. 6,585,989 combines a silver containing zeolite and the organic antimicrobial agent TRICLOSAN™ (2,4,4′-trichloro-2′-hydroxydiphenyl ether) in polyethylene and polypropylene to yield improved UV stabilization (less yellowness) in accelerated weathering tests. Kimura in U.S. Pat. No. 7,041,723 discloses that for polyolefins containing an antimicrobial combination consisting of (A) a silver containing zeolite and either (B) a silver ion-containing phosphate or (C) a soluble silver ion-containing glass powder, some drawbacks of each antimicrobial agent are mitigated, including the reduction of discoloration from UV light exposure in accelerated weathering tests.

There is a need to provide improved compositions comprising melt-processed polymers and silver-based antimicrobial agents of greater antimicrobial efficacy and reduced discoloration. Toward this end, it is often desirable to reduce the grain size of antimicrobial agents to increase the total surface area, reactivity, and dispersability. A further particular need exists to substantially reduce the degree of unwanted discoloration within a polymer composite and the resultant article containing a silver-based antimicrobial agent, with reduced grain-size and/or grain-size distribution resulting from the inclusion of an additive.

### SUMMARY OF THE INVENTION

In accordance with one embodiment, the present invention is directed towards a polymer composite comprising a melt-processed polymer compounded with a color stabilizer comprising a bromate or iodate ion, and a silver-based antimicrobial agent. In a further embodiment, the invention is also directed towards a process of preparing such a composite, comprising compounding the color stabilizer with the melt-processed polymer prior to or simultaneously with compounding of the silver-based antimicrobial agent. In such process, the silver-based antimicrobial agent may be precipitated in the presence of a grain-size controlling additive and the color stabilizer, and the color stabilizer is compounded with the melt-processed polymer simultaneously with compounding of the silver-based antimicrobial agent. The specified color stabilizers are superior in inhibiting thermal and light induced discoloration of melt-processed polymers in the presence of compounded silver-based antimicrobial agents.

In a further specific embodiment, the melt-processed polymer may be first compounded with a color stabilizer additive comprising a bromate or iodate ion, and then subsequently compounded with the silver-based antimicrobial agent. In further specific embodiments, the silver-based antimicrobial agent is silver sulfate, which may be precipitated in the presence of a grain-size controlling additive comprising an organo-sulfate or organo-sulfonate ion.

### DESCRIPTION OF THE INVENTION

The object of the present invention is to provide improvements in color of melt-processed polymers and plastic objects made there of, within which a silver-based antimicrobial agent has been introduced.

Silver-based antimicrobial agents suitable for use in the invention are varied and may be classified as metallic silver, salts of silver ion, silver ion carriers or silver ion-exchange compounds, and silver containing glasses. Metallic silver is available in a number of physical forms, including coatings, microscopic filaments and particles of various shapes and sizes. Silver ion salts may be classified according to their aqueous solubility as highly, moderately or sparingly soluble. Examples of highly soluble silver salts are silver nitrate, acetate, citrate, chlorate, fluoride, perchlorate, propionate, etc. Some examples of moderately soluble silver ion salts are silver benzotriazole, borate, carbonate, lactate, sulfate, etc. Some examples of sparingly soluble silver ion salts are silver chloride, bromide, iodide, behenate, oxide and peroxide. Examples of silver ion carriers are the various forms of silver containing zeolite and silver deposited onto calcium phosphate or calcium silicate or silica gel. Silver ion-exchange compounds are exemplified by the silver zirconium phosphate type layered materials. Silver glasses include silicate, aluminosilicate and aluminozirconosilicate hosts that contain silver, for example. The choice of a silver-based antimicrobial agent is dependent on many factors given the particular polymer host and the end use of the composite. A preferred silver-based antimicrobial agent for incorporation into polyolefins and polyesters is silver sulfate.

In particular embodiments, the present invention enables composites comprising melt-processed polypropylene or polyethylene terephthalate compounded with at least 0.1 wt % of silver sulfate, and wherein the presence of the color stabilizer results in lower colorimetric a* and b* values and a higher calorimetric L* value for the composite relative to those obtained for a corresponding melt-processed polymer compounded with the same wt % of silver sulfate in the absence of the color stabilizer.

Silver sulfate employed in polymer composites of the present invention may be obtained from various commercially available sources (e.g., Riverside Chemical, Aldrich Chemical), and may be produced by conventional aqueous precipitation methods. The reaction of equimolar amounts of aqueous solutions of silver nitrate and sulfuric acid to form silver sulfate was described by Th. W. Richards and G. Jones, Z. anorg. Allg. Chem. 55, 72 (1907). A similar precipitation process using sodium sulfate as the source of sulfate ion was reported by O. Honigschmid and R. Sachtleben, Z. anorg. Allg. Chem. 195, 207 (1931). An alternate method employing the immersion of silver metal in a sulfuric acid solution was also reported by O. Honigschmid and R. Sachtleben (loc. cit.). Precipitation of finely divided silver sulfate from an aqueous solution via the addition of alcohol was later reported by H. Hahn and E. Gilbert, Z. anorg. Allg. Chem. 258, 91 (1949).

In accordance with a preferred embodiment, silver sulfate may be obtained by a process wherein an aqueous solution of a soluble silver salt and an aqueous solution of a source of inorganic sulfate ion are added together under turbulent mixing conditions in a precipitation reactor. Soluble silver salts that may be employed in the process include silver nitrate, acetate, propionate, chlorate, perchlorate, fluoride, lactate, etc. Inorganic sulfate ion sources include sulfuric acid, ammonium sulfate, alkali metal (lithium, sodium, potassium, rubidium, cesium) sulfate, and alkaline earth metal (such as magnesium) sulfate, transition metal (such as zinc, cadmium, zirconium, yttrium, copper, nickel, iron) sulfate, etc. In specific embodiments, the soluble silver salt employed is preferably silver nitrate and the source of inorganic sulfate ion is preferably sulfuric acid, more preferably ammonium sulfate.

Turbulent mixing conditions employed in precipitation reactors may be obtained by means of conventional stirrers and impellers. In a specific embodiment, the reactants are contacted in a highly agitated zone of a precipitation reactor. Mixing apparatus, which may be used in accordance with such embodiment, includes rotary agitators of the type which have been previously disclosed for use in the photographic silver halide emulsion art for precipitating silver halide particles by reaction of simultaneously introduced silver and halide salt solution feed streams. Such rotary agitators may include, e.g., turbines, marine propellers, discs, and other mixing impellers known in the art (see, e.g., U.S. Pat. No. 3,415,650; U.S. Pat. No. 6,513,965, U.S. Pat. No. 6,422,736; U.S. Pat. No. 5,690,428, U.S. Pat. No. 5,334,359, U.S. Pat. No. 4,289,733; U.S. Pat. No. 5,096,690; U.S. Pat. No. 4,666,669, EP 1156875, WO-0160511).

While the specific configurations of the rotary agitators which may be employed may vary significantly, they preferably will each employ at least one impeller having a surface and a diameter, which impeller is effective in creating a highly agitated zone in the vicinity of the agitator. The term “highly agitated zone” describes a zone in the close proximity of the agitator within which a significant fraction of the power provided for mixing is dissipated by the material flow. Typically, it is contained within a distance of one impeller diameter from a rotary impeller surface. Introduction of a reactant feed stream into a precipitation reactor in close proximity to a rotary mixer, such that the feed stream is introduced into a relatively highly agitated zone created by the action of the rotary agitator provides for accomplishing meso-, micro-, and macro-mixing of the feed stream components to practically useful degrees. Depending on the processing fluid properties and the dynamic time scales of transfer or transformation processes associated with the particular materials employed, the rotary agitator preferably employed may be selected to optimize meso-, micro-, and macro-mixing to varying practically useful degrees.

Mixing apparatus that may be employed in one particular embodiment includes mixing devices of the type disclosed in Research Disclosure, Vol. 382, February 1996, Item 38213. In such apparatus, means are provided for introducing feed streams from a remote source by conduits that terminate close to an adjacent inlet zone of the mixing device (less than one impeller diameter from the surface of the mixer impeller). To facilitate mixing of multiple feed streams, they may be introduced in opposing direction in the vicinity of the inlet zone of the mixing device. The mixing device is vertically disposed in a reaction vessel, and attached to the end of a shaft driven at high speed by a suitable means, such as a motor. The lower end of the rotating mixing device is spaced up from the bottom of the reaction vessel, but beneath the surface of the fluid contained within the vessel. Baffles, sufficient in number to inhibit horizontal rotation of the contents of the vessel, may be located around the mixing device. Such mixing devices are also schematically depicted in U.S. Pat. Nos. 5,549,879 and 6,048,683; the disclosures of which are incorporated by reference.

Mixing apparatus that may be employed in another embodiment includes mixers that facilitate separate control of feed stream dispersion (micromixing and mesomixing) and bulk circulation in the precipitation reactor (macromixing), such as descried in U.S. Pat. No. 6,422,736, the disclosure of which is incorporated by reference. Such apparatus comprises a vertically oriented draft tube, a bottom impeller positioned in the draft tube, and a top impeller positioned in the draft tube above the first impeller and spaced there from a distance sufficient for independent operation. The bottom impeller is preferably a flat blade turbine (FBT) and is used to efficiently disperse the feed streams, which are added at the bottom of the draft tube. The top impeller is preferably a pitched blade turbine (PBT) and is used to circulate the bulk fluid through the draft tube in an upward direction providing a narrow circulation time distribution through the reaction zone. Appropriate baffling may be used. The two impellers are placed at a distance such that independent operation is obtained. This independent operation and the simplicity of its geometry are features that make this mixer well suited in the scale-up of precipitation processes. Such apparatus provides intense micromixing, that is, it provides very high power dissipation in the region of feed stream introduction.

Once formed in an aqueous precipitation process, the resulting silver sulfate particles may be washed, dried and collected as a white free-flowing powder. In terms of particle size metrics, the precipitation process preferably results in producing both a small primary crystallite size and a small grain size, along with a narrow grain size distribution. Crystallites may become agglomerated into larger sized particles referred to as grains. While not limited in the present invention, average grain sizes of less than 70 micrometers, less than 50 micrometers, less than 10 micrometers, and even less than 1 micrometer may be desired for particular product applications. In a preferred process, the silver sulfate is precipitated in the presence of a grain-size or grain-size distribution reducing additive, such as an organo-phosphate, organo-phosphite or organo-phosphonate. A preferred means of controlling the grain size of precipitated silver sulfate with additives comprising organo-sulfates or organo-sulfonates is disclosed in U.S. patent application Ser. No. 11/399,754 filed Apr. 7, 2006, the disclosure of which is hereby incorporated by reference in its entirety. Another specific means of controlling the grain size of precipitated silver sulfate is with various inorganic additives, as disclosed in commonly assigned, concurrently filed, copending U.S. Ser. No. ______ (Kodak Docket 93821), the disclosure of which is hereby incorporated by reference in its entirety.

In accordance with the invention, a color stabilizer additive comprising a bromate or iodate ion, or mixtures thereof, is employed to minimize discoloration of melt-processed polymers due to compounding of silver-based antimicrobial agents therein. A preferred color stabilizing additive of the invention comprises an iodate ion or salt thereof. Suitable counter ions for the iodate ion include cations of the alkali metals (such as sodium and potassium), alkaline earth metals (such as calcium and magnesium), and hydronium or ammonium ion. The silver-based antimicrobial agents are preferably precipitated in the presence of grain-size controlling additives. In specific embodiments the silver-based antimicrobial agent is silver sulfate and the grain-size controlling additive comprises an organo-sulfate or organo-sulfonate ion. When such a combination of a silver-based antimicrobial agent precipitated in the presence of a grain-size controlling additive is compounded within a melt-process polymer composite along with a further additive comprising a bromate or iodate ion, a surprising reduction in unwanted aesthetically displeasing discoloration is provided.

In accordance with the process of a specific embodiment of the present invention, a color stabilizing additive comprising a bromate or iodate ion, or mixtures thereof, can be combined with melt-processed polymers to form an initial composition, wherein the initial composition is defined as the color stabilizing additives of the invention dispersed in polymer after thermal processing. After the initial composition is made, a composite of the invention is made, wherein the composite is defined as a silver-based antimicrobial agent, dispersed in the initial composition. In a preferred embodiment the silver-based antimicrobial agent is silver sulfate, Ag₂SO₄. Silver sulfate can be used as made, typically by a commercial precipitation process or by the various precipitation processes described above, or by the specific precipitation processes described below, or can be reduced in particle size using a mortar and pestle, ball mill, jet mill, attrition mill, and other techniques used for particle size reduction of solid particles. In a preferred process, the silver sulfate is precipitated in the presence of a grain-size or grain-size distribution reducing additive, such as a fatty acid, organo-phosphate, organo-phosphite or organo-phosphonate. In a particular preferred embodiment, the grain-size and/or grain-size distribution reducing additive is an organo-sulfate or organo-sulfonate compound.

A preferred method for making the composite of the silver-based antimicrobial agent, together with any optional addenda, in polymer is melt blending with the thermoplastic polymer using any suitable mixing device such as a single screw compounder, blender, paddle compounder such as a Brabender, spatula, press, extruder, or molder such as an injection molder. However, it is preferred to use a suitable batch mixer, continuous mixer or twin-screw compounder such as a PolyLab or Leistritz, to ensure proper mixing. Twin-screw extruders are built on a building block principle. Thus, mixing of the silver-based antimicrobial agent, temperature, mixing rotations per minute (rpm), residence time of resin, as well as point of addition of the silver-based antimicrobial agent can be easily changed by changing screw design, barrel design and processing parameters. Similar machines are also provided by other twin-screw compounder manufacturers like Werner and Pfleiderrer, Berstorff, and the like, which can be operated either in the co-rotating or the counter-rotating mode.

One method for making the initial composition is to melt polymer in a glass, metal or other suitable vessel, followed by addition of the color stabilizers of the invention. The polymer and stabilizers are mixed using a spatula until the stabilizers are properly dispersed in the polymer, followed by the addition of a silver-based antimicrobial such as silver sulfate. The silver-based antimicrobial is mixed using a spatula until it is appropriately dispersed in the polymer. Another method for making the composite is to melt the polymer in a small compounder, such as a Brabender compounder, followed by addition of the stabilizers, compound until the stabilizers are properly dispersed in the polymer, followed by addition of the silver-based antimicrobial agent (e.g. silver sulfate) until it is appropriately dispersed in the polymer. Yet in another method such as in the case of a twin-screw compounder, this compounder is provided with main feeders through which polymer pellets or powders are fed. Stabilizers can be mixed with and fed simultaneously with the polymer pellets or powders. Stabilizers can also be fed using a feeder located downline from the polymer feeder. Both procedures will produce an initial composition. The silver-based antimicrobial agent (e.g. silver sulfate) is then fed using a top feeder or using a side stuffer. If the side stuffer is used to feed the silver-based antimicrobial agent then the feeder screw design needs to be appropriately configured. The preferred mode of addition of the silver-based antimicrobial material (e.g. silver sulfate) to the thermoplastic polymer is by the use of a side stuffer, although a top feeder can be used, to ensure proper viscous mixing and to ensure dispersion of the silver-based antimicrobial agent through the initial composition polymer matrix as well as to control the thermal history. The resulting composite material obtained after compounding can be further processed into pellets, granules, strands, ribbons, fibers, powder, films, plaques, foams and the like for subsequent use.

Alternatively, the initial composition containing the color stabilizers of the invention can be compounded and collected, then fed through the main feeder before addition of the silver-based antimicrobial agent. In yet another embodiment, the silver-based antimicrobial agent can be pre-dispersed along with the color stabilizers of the invention in the initial composition and compounded. In a preferred embodiment the color stabilizers of the invention are added at least in part during the preparation of the silver-based antimicrobial agent. In the case of silver sulfate, it is preferred to add the color stabilizers at least in part during the precipitation process to achieve good dispersal and excellent reduction of discoloration. More specifically, the bromate or iodate ion containing additives may be added to the precipitation reactor before, along with, or after the addition of the soluble silver salt.

The weight ratio of silver-based antimicrobial agent (e.g. silver sulfate) to melt-processed polymer in the composite may vary widely depending on the end-use application. However, it is preferred that the ratio is at least 0.01:99.99, more preferably at least 0.05:99.95. The invention is particularly advantageous with respect to preventing undesired discoloration for polyolefin and polyester compositions comprising at least about 0.1 wt %, more preferably at least about 0.25 wt %, and most preferably at least about 1.0 wt % silver sulfate. Preferably, the compositions need not contain more than about 10 wt % of silver-based antimicrobial agent to exhibit antimicrobial efficacy. The resulting composite could be a masterbatch that can be further diluted in a compounder where the masterbatch is mixed with melt-processed polymer either simultaneously, same feeder, or sequentially, multiple feeders, resulting in a dilution of the masterbatch.

The weight ratio of color stabilizers of the invention to melt-processed polymer and to the silver-based antimicrobial in the composite may vary widely depending on 1) the type of color stabilizer, 2) the processes used to introduce the color stabilizers and silver-based antimicrobial into the composite, 3) the type and amount of silver-based antimicrobial present, 4) the type and amount of the silver-based antimicrobial grain-size or grain-size distribution controlling additive present, 5) the type of polymer and other polymer additives present, and 6) on the end-use of the polymer composite. If the weight ratio of either the grain-size or grain-size distribution controlling additive or the color stabilizing additive become too great, then the cost or mechanical properties of the polymer composite will suffer. Generally speaking, the weight ratio of the grain-size or grain-size distribution controlling additive to silver-based antimicrobial agent may range from zero up to a maximum of about 20 percent, preferably less than 10 percent, and more preferably less than 5 percent. The useful range of color stabilizer of the invention will vary widely based on factors 1-6 described above. For the process in which the color stabilizer is precompounded into the polymer prior to addition of the silver-based antimicrobial agent, the weight ratio of the color stabilizer to the silver-based antimicrobial agent will typically be at least 0.1 percent, less than about 30%, and preferably less than about 20%. For the process in which the color stabilizer is added during the preparation of the silver-based antimicrobial agent, the weight ratio of the color stabilizer to the silver-based antimicrobial agent will typically be at least 0.01 percent, less than about 10 percent, and preferably less than about 2 percent.

The basic procedures followed in producing the inventive stabilized antimicrobial plastic material or article comprise standard plastic formation techniques. Several basic methods exist of incorporating additives (such as silver-based antimicrobials and the inventive color stabilizers, for example) within polymer articles on a large scale. One method is to dry blend a mixture of polymer, additives (e.g. modifiers and stabilizers), antimicrobials; melt the dry mix together in an extruder to form a molten composition which is then pelletized; and melting and subsequently molding such pellets into a plastic article. One preferred method is to dry blend a mixture of polymer and additives (e.g. modifiers and stabilizers), melt the dry mix together in an extruder to form a molten composition, followed by addition of the antimicrobial. Alternatively, one may mix conventional resin pellets and masterbatch concentrates containing the stabilizers and/or antimicrobial additives and molding in conventional molding equipment. Additional methods and preferred order of addition of additives, such as adding the color stabilizers of the invention prior to adding the silver-based antimicrobial agent, are described further below. The aforementioned molding steps may be performed preferably with injection molding equipment; however, other plastic-forming operations may also be utilized such as, and without limitation, blow molding, fiber extrusion, film formation, compression molding, rotational molding, and the like. These alternative plastic article-forming operations would be well understood and appreciated by one of ordinary skill in this art.

Polymers suitable to the invention include those melt-processed between about 60-500° C. A non-limiting list of such polymeric materials include:

1. Polymers of monoolefins and diolefins, for example polypropylene, polyisobutylene, polybut-1-ene, poly-4-methylpent-1-ene, polyvinylcyclohexane, polyisoprene or polybutadiene, as well as polymers of cycloolefins, for instance of cyclopentene or norbornene, polyethylene (which optionally can be crosslinked, known as PEX), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE).

2. Mixtures of the polymers mentioned above, for example mixtures of polypropylene with polyisobutylene, polypropylene with polyethylene (for example PP/HDPE, PP/LDPE) and mixtures of different types of polyethylene (for example LDPE/HDPE).

3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene like COC), ethylene/1-olefins copolymers, where the 1-olefin is generated in-situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.

4. Vinyl polymers and copolymers used in thermoplastics, such as poly(vinyl chloride) and derivatives thereof; polystyrene and derivatives thereof; poly(acrylic acid); polyacrylates; polycyanoacrylate; poly(alkyl acrylates) such as poly(methyl acrylate) and poly(ethyl acrylate); poly(methacrylic acid) (PMAA); poly(methyl methacrylate) (PMMA); polyacrylamide; polyacrylonitrile; polyisobutylene; polybutenes; polydicyclopentadiene; polytetrafluoroethylene (TEFLON); polytrichlorofluoroethylene; polychlorotrifluoroethylene; poly(vinyl acetate); poly(vinyl alcohol); poly(vinyl butyral) (BUTVAR™); poly(N-vinyl carbazole), poly(vinyl chloride-acetate); poly(vinyl ethers); poly(vinylidene chloride); poly(vinylidene fluoride); poly(vinyl fluoride); poly(vinyl pyrolidone); poly(vinyl pyrrolidinone); allyl resins (crosslinked diallyl and triallyl esters).

5. Polyesters such as the commercially available linear polyesters, for example poly(ethylene terephthalate) (PET), poly(trimethylene terephthalate) (PIT), poly(butylene terephthalate) (PBT), poly(ethylene naphthalene-2,6-dicarboxylate) (PEN), poly(4-hydroxybenzoate), poly(bisphenol A terephthalate/isophthalate), poly(1,4-dihydroxymethylcyclohexyl terephthalate), polycarbonate (such as bisphenol A polycarbonate), polycaprolactone, poly(glycolic acid), poly(lactic acid); the bacterial polyesters known collectively as poly(hydroxy alkanoates) (PHA), such as poly(3-hydroxybutyrate) (PHB), phenyl-substituted PHA and unsaturated PHA; and the man-made random copolymer poly(3-hydroxybutyrate-co-3-hydroxyvalerate) (PHBV); the hyperbranched polyesters; the crosslinked or network polyesters commonly called alkyds or polyester resins, including i) the saturated polyester resins that utilize polyfunctional alcohols and acids, such as glycerol, pentaerythritol, sorbitol, citric acid, trimellitic acid, or pyromellitic dianhydride, to crosslink during the esterification reaction, typically used to prepare oil-modified alkylds and styrenated alkyds, and ii) the unsaturated polyester resins that utilize double bonds incorporated into the polyester backbone to crosslink in a separate addition polymerization reaction step.

6. Polyamides and polypeptides, including, for example, the commercially available commodity nylons such as Nylon 6 (polycaprolactam) and Nylon 66 [poly(hexamethylene adipamide)]; commercial specialty nylons such as Nylon 7 [poly(7-heptanamide)], Nylon 8 [polycapryllactam], Nylon 9 [poly(9-nonanamide)], Nylon 11 [poly(11-undecanamide)], Nylon 12 [polylauryllactam], Nylon 46 [poly(tetramethylene adipamide)] Nylon 69 [poly(hexamethylene azelamide)] Nylon 610 [poly(hexamethylene sebacamide)] Nylon 612 [poly(hexamethylene dodecanediamide)]; commercially available polymers poly(methylene-4,4′-dicyclohexylene dodecanediamide), poly(1,4-cyclohexylenedimethylene suberamide), poly(m-phenylene isophthalamide) (DuPont NOMEX™), poly(p-phenylene terephthalamide) (DuPont KEVLAR™), poly(2,4,4-trimethylhexamethylene terephthalamide), poly(2,2,4-trimethylhexamethylene terephthalamide); other nylons such as Nylon 1 and derivatives thereof, Nylon 3 (poly-β-alanine), Nylon 4, Nylon 5; branched nylons; wholly aromatic polyamides; aliphatic-aromatic polyamides; polyureas; polyurethane fibers, such as those used in “hard” segments of elastomeric AB block copolymers (DuPont Spandex technology), in reaction injection molding (RIM) systems for making automobile parts (e.g. bumpers), and in rigid and flexible foams (such as HYPOL™ available from W. R. Grace & Co. (USA)); polyhydrazides; polyimides, such as poly(4,4′-oxydiphenylene-pyromellitimide) (DuPont KAPTON™); polyaspartimide; polyimidesulfones; polysulfonamides; polyphosphonamides; and proteins, such as wool, silk, collagen, recombinant human collagen, gelatin and regenerated protein.

7. Other polymers used in engineering plastics, including, for example, polyethers such as poly(ethylene oxide) (PEO), poly(ethylene glycol), polytetrahydrofuran or other polyethers used, for instance, in “soft” segments of elastomeric AB block copolymers (DuPont Spandex technology), polyoxymethylene (acetal), poly(phenylene oxide) (PPO), poly(hexafluoropropylene oxide), poly[3,3-(dichloromethyl)trimethylene oxide], polytetrahydrofuran, polyetherketones (PEK), polyetherketoneketones (PEKK), polyetheretherketones (PEEK), polyetherketoneether ketoneketones (PEKEKK), polyetherimides (PEI); polyethersulfones (PES) such as VICTREX available from ICI; polysulfones (PSU) such as ASTREL™ available from 3M; polysupersulfones (PSS); polybenzimidazoles (PBI); polysulfides such as poly(p-phenylene sulfide) (PPS) and poly(alkylene polysulfides) (known as Thiokol rubbers); and thermoplastic elastomers such as polyether block amides (PEBAX™).

8. Polymers used in thermosetting plastics, laminates and adhesives, including, for example, phenol-formaldehydes (often referred to as phenolic resins), chemically modified phenolic resins optionally containing furfural, 5-hydroxymethylfurfural, acrolein, acetaldehyde, butyraldehyde, resorcinol, bisphenol A, o- or p-cresol, o- or p-chlorophenol, p-t-butylphenol, p-phenylphenol, p-n-octylphenol, unsaturated phenols derived from cashew nut shell liquid (such as cardanol), unsaturated phenols from tung oil (such as α-eleostearic acid), 2-allylphenol, naturally occurring phenols such as hydrolyzable tannins (pyrogallol, ellagic acid, glucose esters or condensed forms of gallic acid), condensed tannins (flavonoid units linked together with carbohydrates) and lignin; phosphate esterified phonolic resins; furan resins; bisphenol A-furfural resins; unsaturated polyesters; polyether epoxy resins; amino resins such as urea-formaldehydes and melamine-formaldehydes (FORMICA™ and BASOFIL™); resoles; novolacs; crosslinked novolacs (e.g. KYNOL™); epoxy cresol novolacs, and epoxy phenol novalacs.

9. Polymers and copolymers used in synthetic elastomers, including, for example, poly(acrylonitrile-butadiene); poly(styrene-butadiene) (SBR), poly(styrene-butadiene) block and star copolymers; poly(styrene-acrlyonitrile) (SAN), poly(styrene-maleic anhydride) (SMA), poly(styrene-methylmethacrylate); poly(acrylonitrile-butadiene-styrene) (ABS); poly(acrylonitrile-chlorinated polyethylene-styrene); poly(acrylonitrile-butadiene-acrylate); polybutadiene, specifically the cis-1,4 polymer; ethylene-propylene-diene-monomer (EPDM); neoprene rubbers, such as cis or trans-1,4-polychloroprene and 1,2-polychloroprene; cis or trans-1,4-polyisoprene; poly(isobutylene-isoprene); poly(isobutylene-cyclopentadiene); poly(1-octenylene)(polyoctenamer); poly(1,3-cyclo-pentenylenevinylene)(norbornene polymer).

10. Other natural polymers, including, for example, natural rubbers such as hevea(cis-1,4-polyisoprene), guayule(cis-1,4-polyisoprene), guta percha(trans-1,4-polyisoprene), balata(trans-1,4-polyisoprene) and chicle(cis and trans-1,4-polyisoprene); lignin; humus; shellac; amber; Tall oil derived polymers (rosin); asphaltenes (bitumens); polysaccharides, such as native cellulose derived from seed hair fibers (cotton, kapok, coir), bast fibers (flax, hemp, jute, ramie) and leaf fibers (manila hemp, sisal hemp); regenerated cellulose such as viscose rayon and cellophane; derivatives of cellulose including the nitrate (e.g. CELLULOID™), acetate (fibers of which are known as cellulose rayon), propionate, methacrylate, crotonate and butylate esters of cellulose; acetate-propionate and acetate-butyrate esters of cellulose, and mixtures thereof; the methyl, ethyl, carboxymethyl, aminoethyl, mercaptoethyl, hydroxylethyl, hydroxypropyl and benzyl ether derivatives of cellulose (e.g. “thermoplastic starches”); nitrocellulose; vinyl and nonvinyl graft copolymers of cellulose (e.g. ETHYLOSE™); crosslinked cellulose; hemicelluloses (amorphous) such as xylan, mannan, araban and galactans; starch, including amylase and amylopectin; derivatives of starch such as allylstarch, hydroxyethylstarch, starch nitrate, starch acetate, vinyl graft copolymers of starch such as stryrenated starch; crosslinked starch made using, for instance, epichlorohydrin; chitin; chitosan; alginic acid polymer; carrageenin; agar; glycogen; dextran; inulin; and natural gums such as gum arabic, gum tragacanth, guar gum, xanthum gum, gellan gum and locust bean gum.

11. Heterocyclic polymers, including, for example, polypyrroles, polypyrazoles, polyfurans, polythiophenes, polycyanurates, polyphthalocyanines, polybenzoxazoles, polybenzothiazoles, polyimidazopyrrolones, poly(1,3,4-oxadiazoles) (POD), poly(1,2,4-triazoles), poly(1,3,4-thiadiazoles), polyhydantoins, poly(parabanic acids) also known as poly(1,3-imidazolidine-2,4,5-triones), polythiazolines, polyimidines, polybenzoxazinone, polybenzoxazinediones, polyisoindoloquinazolinedione, polytetraazopyrene, polyquinolines, polyanthrazolines, poly(as-triazines).

12. Other organic polymers, including, for example, polyamines such as polyanilines, Mannich-base polymers; and polyaziridines; polycarbodiimides; polyimines (also called azomethine or Schiff base polymers); polyamidines; polyisocyanides; azopolymers; polyacetylenes; poly(p-phenylene); poly(o-xylylene); poly(m-xylylene); poly(p-xylylene) and chlorinated poly(p-xylylene) (Union Carbide PARYLENE™); polyketones; Friedel-Crafts polymers; Diels-Alder polymers; aliphatic and aromatic polyanhydrides; ionens; ionene-polyether-ionene ABA block copolymers; halatopolymers; and synthetic bioabsorbable polymers, for example, polyesters/polyactones such as polymers of polyglycolic acid, glycolide, lactic acid, lactide, dioxanone, trimethylene carbonate, polyanhydrides, polyesteramides, polyortheoesters, polyphosphazenes, and copolymers of these and related polymers.

13. Inorganic polymers, including, for example, polysiloxanes, polysilanes, polyphosphazines, carborane polymers, ploycarboranesiloxanes (DEXSIL™ and UCARSIL™), poly(sulfur nitride), polymeric sulfur, polymeric selenium, polymeric tellurium, boron nitride fibers, poly(vinyl metallocenes) of ferrocene and ruthenocene, polyesters and polyamides containing metallocenes in the polymer backbone, poly(ferrocenylsilane); poly(ferrocenylethylene); organometallic vinyl polymers containing manganese, palladium or tin, and copolymers of the former with poly(methyl methacrylate), which are used in biocidal paints for marine applications such as ship hulls and off-shore drilling platforms; metal-containing polyesters and polyamides; polymeric nickel(o)-cyclooctatetraene, polymeric norbornadiene-silver nitrate; arylethynyl copper polymers; coordination polymers, such as polymers resulting from the reaction of bis(1,2-dioxime) with nickel acetate, phthalocyanine-type polymers, network transition metal polyphthalocyanines linked through imide or benzimidazole groups, cofacially linked polyphthalocyanines, ligand exchange polymers resulting from the reaction of bis(β-diketone) and metal acetylacetonates or tetrabutyl titanate, polymers resulting from the reaction of bis(8-hydroxy-5-quinolyl) derivative, and its thiol analogs, with metal acetylacetonates; polymeric chelates, such as polyamides resulting from the reaction of diacid chloride with thiopicolinamides, and vinyl polymers containing pendant crown ethers, such as poly(4′-vinylbenzo-18-crown-6).

Homopolymers, copolymers and blends of the polymers described above may have any stereostructure, including syndiotactic, isotactic, hemi-isotactic or atactic. Stereoblock polymers are also included. The polymers may be amorphous, crystalline, semicrystalline or mixtures thereof; and possess a range of melt index, preferably from about 0.3 to about 99. The polymers described above may be further derivatized or functionalized (e.g. chlorinated, brominated, fluorinated, sulfonated, chlorosulfonated, saponified, hydroborated, epoxidated) to impart other features (e.g. physical/chemical, end-group conversion, bio and photodegradation), or in preparation for subsequent crosslinking, block and graft copolymerization.

Polyolefins, preferably polyethylene and polypropylene, and vinyl polymers exemplified in the preceding paragraphs can be prepared by different, and especially by the following, methods: a) radical polymerization (normally under high pressure and at elevated temperature); b) catalytic polymerization using a catalyst that normally contains one or more than one metal of groups IVb, Vb, VIb or VIII of the Periodic Table. These metals usually have one or more than one ligand, typically oxides, halides, alcoholates, esters, ethers, amines, alkyls, alkenyls and/or aryls that may be either π- or σ-coordinated. These metal complexes may be in the free form or fixed on substrates, typically on activated magnesium chloride, titanium(III)chloride, alumina or silicon oxide. These catalysts may be soluble or insoluble in the polymerization medium. The catalysts can be used by themselves in the polymerization or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene or single site catalysts (SSC).

Polyesters for use in the invention may be manufactured by any known synthetic method, including, for example, direct esterification, transesterification, acidolysis, the reaction of alcohols with acyl chlorides or anhydrides, the reaction of carboxylic acids with epoxides or alkylhalides, and by ring-opening reactions of cyclic esters. Copolyesters, copolymers containing a polyester, and polymer blends, such as engineering plastics comprising polyblends of polycarbonate with PBT or ABS (acrylonitrile-butadiene-styrene) are specifically contemplated. Solution and interfacial (phase-transfer) methods, catalyzed low temperature and high temperature synthetic methods may be employed.

Polyamides for use in the invention can be manufactured by any known method, including, for example, solution polymerization, interfacial polymerization in which an acid chloride and a diamine are used as raw materials, by melt polymerization, solid-phase polymerization, or melt extrusion polymerization in which a dicarboxylic acid and a diamine are used as raw materials.

Besides the polymer, silver-based antimicrobial agents, grain-size and color controlling additives, the composite material of the invention can include optional addenda. These addenda can include nucleating agents, antiblocking agents, antioxidants, basic co-stabilizers, blowing agents, fillers and reinforcing agents, plasticizers, light stabilizers and UV inhibitors, hindered amine stabilizers, metal inhibitors, surfactants, intercalates, lactones, compatibilizers, coupling agents, impact modifiers, chain extenders, colorants, dyes (such as ultramarine blue and cobalt violet), pigments (such as titanium oxide, zinc oxide, talc, calcium carbonate), lubricants, emulsifiers, antistatic agents, dispersants such as fatty amides (e.g., stearamide), metallic salts of fatty acids (e.g., zinc stearate, magnesium stearate), processing aids, additional antioxidants, synergists, fluorescent whiteners, fire retardants, abrasives or roughening agents such as diatomaceous earth, cross linking agents, foaming agents and the like. These optional addenda and their corresponding amounts can be chosen according to need. Incorporation of these optional addenda in the purge material can be accomplished by any known method.

Polymer composites of the invention may be fabricated in any known shape, such as fibers, films or blocks. Fibers may be solid or hollow, and either round or non-round in cross section. The latter may assume ribbon, wedge (triangular) and core (hub & spokes), multilobe (such as trilobe, cross, star and higher multilobe), elliptical and channeled cross sections (designed to promote moisture wicking, such as in COOLMAX™ fibers). Bicomponent and multicomponent fiber configurations, such a concentric sheath/core, eccentric sheath/core, side-by-side, pie wedge, hollow pie wedge, core pie wedge, three islands and “islands-in-the-sea”, are specifically contemplated.

Splittable synthetic fibers, such as those spun of at least two dissimilar polymers in either segment-splittable or dissolvable “islands-in-the-sea” formats, are contemplated for use in the invention. Segment splittable fibers are typically spun with 2 to 32 segments in a round fiber, although 16 segments in a pie wedge (or “citrus”) cross section and 8 segments in a hollow or core pie wedge cross section are commonly used at production scales. Microfibers of about 2-4 microns diameter, typically with a wedge shaped cross section, are produced after some energy input received during subsequent textile processing (e.g. hydro-entanglement, carding, needlepunching, airlaying, wetlaying) causes the segments to separate. Segmented ribbon and segmented multilobe (e.g. segmented cross and tipped trilobe) cross sections offer enhanced fiber splittability, but the cost of spinnerets capable of forming these cross section shapes is high. Splittable segmented bicomponent fibers of nylon/polyester are commercially available (e.g. DUOTEX™ and STARFIBER™). Other polymer combinations used in splittable bicomponent fibers include polypropylene/nylon, polypropylene/polyester, polypropylene/poly(acrylonitrile), polypropylene/polyurethane; all-polyester splittable fibers made from poly(lactic acid)/PET, and all-polyolefin splittable fibers made from polypropylene/poly(methyl pentene).

Splittable fiber technology as originally disclosed in U.S. Pat. No. 3,705,226 employed an “islands-in-the-sea” format in which a staple fiber was spun with extremely fine diameter PET fibers surrounded by a dissolvable “sea” of copolymer. Suitable dissolving polymers include polystyrene (soluble in organic solvents), specific co-polyesters of poly(lactic acid), polyvinyl alcohol, thermoplastic starches and other co-polyesters soluble in hot water. Nylon microfibers of about 6 micron diameter have been produced commercially from a fiber originally containing 37 islands of Nylon 6 in an alkali-soluble copolyester sea. Island/sea fibers with up to 600 islands have yielded microfibers about 1 micron in diameter.

Melt-processed polymers and plastics comprising a silver-based antimicrobial agent, optionally a grain-size controlling additive, and a color stabilizing additive of the invention to provide antimicrobial (antibacterial and/or antifungal) or antiviral protection with reduced discoloration may be employed in a variety of applications. Typical end-use applications include, but are not limited to, extruded and non-extruded face fibers for carpets and area rugs (e.g. rugs with polypropylene face fibers (such as commercial, retail or residential carpet); carpet backing (either primary or secondary backing, comprising woven or nonwoven polypropylene fibers), or the latex adhesive backings used in carpet (commercial, residential or retail)). In addition, melt-processed polymers of the invention may be used in liquid filtration media (such as non-woven filtration media for pools and spas, waste water treatment, potable water treatment, and industrial applications such as metalworking); non-woven air filtration media (such as commercial and residential furnace, HVAC or humidity control filters, air purifiers, and HEPA filters, and cabin air filters for automobiles and airplanes). Further, melt-processed polymers of the invention can be used for outdoor fabrics (such as woven and non-woven car and boat covers, tarps, tents, canvas, ducking, sails, ropes, pool covers, patio upholstery (such as umbrellas, awnings, seating), camping gear and geotextiles), building materials (such as drywall, weather stripping, insulation, housewrap and roof wrap, wall covering fabrics, flooring materials such as cement, concrete, mortar and tile, synthetic marble for kitchen and bath counters and sinks, sanitary ceramic composites, toilets, shower stalls and curtains, sealing materials (such as paint, adhesives for plumbing and packaging, glazing for windows, tile and vitreous china, grout), push buttons for elevators, handrails for stairs, mats, and knobs), industrial equipment (such as tape, tubing, barrier fabrics, conveyor belts, insulators and insulation for wire and cable, plumbing supplies and fixtures, gaskets, collection and storage equipment (including piping systems, silos, tanks and processing vessels) and coatings used on the inside of fire system sprinkler pipes), daily necessities (such as chopping boards, disposable gloves, bowls, kitchen drain baskets, kitchen refuse baskets, kitchen knife handles, chopsticks, tableware, table cloths, napkins, trays, containers, bags, lunch boxes, chopstick cases, dusters, sponges, brooms, mops, wipes, bathroom stools, washbowls, pales, cupboards, soap cases, shampoo holders, toothbrush holders, toothbrushes, dental floss, razor blade handles, wrapping films, food wraps and packaging, canteens, emergency water tanks, toilet seats, hairbrushes, brush bristles, combs, scrubbers, tools and tool handles, cosmetics and cosmetic containers, and clothing). Other uses envisioned include incorporation of the materials of the invention into stationary and writing materials (such as mechanical pencils, ball-point pens, pencils, erasers, floppy disk cases, clipboards, clear paper holders, fancy cases, video tape cases, photo-magnetic disk shells, compact disk cases, desk mats, binders, book covers, writing paper and pocket books), automobile parts (such as a steering wheels, armrests, panels, shift knobs, switches, keys, door knobs, assist grips, truck liners, convertible tops and interior liners), appliances (such as refrigerators, washing machines, vacuum cleaners and bags, air conditioners, clothing irons, humidifiers, dehumidifiers, water cleaners, dish washers and dryers, rice cookers, stationary and mobile telephones, copiers, touch panels for ATM or retail kiosks (e.g. photo-kiosks, etc.)), textile products (such as socks, pantyhose, undergarments, inner liners for jackets, aprons, gloves and helmets, towels, bathing suits, toilet covers, cushion pads, curtains, carpet fibers, fiberfill for quilts and pillows, pillows, sheets, blankets, bedclothes, bedding, mattress ticking, sleeping bags, mattress cover pads and filling, pillow covers, nose and mouth masks, towels, caps, hats, wigs, etc.) goods related to public transportation (such as overhead straps, handles and grips, levers, seats, seat belts, luggage and storage racks) sporting goods (such as balls, nets, pucks, whistles, mouth pieces, racket handles, performance clothing, protective gear, helmets, indoor and outdoor artificial turf, shoe linings and reinforcements, tools, structures and ceremonial objects used in athletic events and the martial arts), medical applications (such as bandages, gauze, catheters, artificial limbs, implants, instruments, scrubs, facemasks, shields, reusable and disposable diapers, sanitary napkins, tampons, condoms, uniforms, gowns and other hospital garments requiring aggressive and harsh cleaning treatments to allow the garment to be safely worm by more than one person). Miscellaneous applications for the invention further involve inclusion in musical instruments (such as in reeds, strings and mouthpieces), contact lens, lens keepers and holders, plastic credit/debit cards, sand-like materials for play boxes, cat and pet litter, jewelry and wrist watch bands.

Application of the antimicrobial composites of the invention for medical uses is specifically contemplated, for example, in a variety of formats:
1. Medical grade substrates, for example, dressings, packings, meshes, films, filtering surfaces, filters, infusers, fibers such as dental floss or sutures, containers or vials, from materials composed in part, for example, of an antimicrobial composite containing polyethylene, high density polyethylene, polyvinylchloride, latex, silicone, cotton, rayon, polyester, nylon, cellulose, acetate, carboxymethylcellulose, alginate, chitin, chitosan and hydrofibers;
2. Biocompatible substrates, comprising antimicrobial composites, preferably containing hydrocolloids, bioabsorbable and/or hygroscopic polymer components such as:
   Synthetic Bioabsorbable Polymers: for example, polyesters/polyactones such as polymers of polyglycolic acid, glycolide, lactic acid, lactide, dioxanone, trimethylene carbonate, polyanhydrides, polyesteramides, polyortheoesters, polyphosphazenes, and copolymers of these and related polymers or monomers, or
   Naturally Derived Polymers:
      Proteins: albumin, fibrin, collagen, elastin;
      Polysaccharides: chitosan, alginates, hyaluronic acid; and
      Biosynthetic Polyesters: 3-hydroxybutyrate polymers;
3. Occlusions or hydrated dressings, optionally impregnated with a powder or solution of an antimicrobial agent, or is used with a topical formulation of an antimicrobial agent, wherein such dressings further comprise an antimicrobial composite, for example, as hydrocolloids, hydrogels, polyethylene, polyurethane, polyinylidine, siloxane or silicone dressings;
4. Gels, formulated with an antimicrobial composite, such materials comprising hydrocolloid polymers such as carboxymethylcellulose, alginate, chitin, chitosan and hydrofibers, together with such ingredients as preservatives, pectin and viscosity enhancers;
5. Creams, lotions, pastes, foams and ointments formulated with antimicrobial composites, for example as emulsions or with drying emollients;
6. Liquids, formulated as solutions, dispersions, or suspensions, further comprising an antimicrobial composite, for example as topical solutions, aerosols, mists, sprays, drops, infusions and instillation solutions for body cavities and tubes such as the bladder, prostate, perintheal, pericharcliar, pleural, intestinal and ailimentary canal;
7. Formulations suitable for administration to the nasal membranes, the oral cavity or to the gastrointestinal tract, formulated with antimicrobial composites in such forms as lozenges, toothpastes, gels, powders, coated dental implants, dental floss or tape, chewing gum, wafers, mouth washes or rinses, drops, sprays, elixirs, syrups, tablets, or capsules;
8. Formulations suitable for vaginal or rectal administration formulated with an antimicrobial composite in such forms as suppositories, dressings, packings, tampons, creams, gels, ointments, pastes, foams, sprays, and solutions for retention enemas or instillations.

Some specific medical end-use applications in which the invention is contemplated for use include, for example:
1. Absorbing and non-absorbing suture materials, formed as monofilament or as braided or twisted multifilaments, employing materials such as silk, polyester, nylon, polypropylene, polyvinylidenefluoride, linen, steel wire, catgut (beef serosa or ovine submucosa), polyglycolactide, polyamide (e.g. polyamide nylon), fibroin, polyglycolic acid and copolymers thereof, such as, for example, a polyglycolide (or polyglycolic acid)/polycaprolactone co-polymer or a polyglycolic acid/polycaprolactam co-polymer);
2. Surgical adhesives and sealants, including, for example, cyanoacrylates, such as butyl-4-cyanoacrylate and the polymer 2-octyl cyanoacrylate (DERMABOND™); polyethylene glycol hydrogels, such as COSEAL™ (Baxter Healthcare Corporation (USA)) and DuraSeal Dural (Confluent Surgical, (USA)), purified bovine serum albumin (BSA) and glutaraldehyde, such as BIOGLUE™ (Cryolife, Inc. (USA)); fibrins, such as CROSSEAL™ (Ethicon, Inc. (USA)) and TISSEAL™; microfibrillar collagens, such as AVITENE™ flour, ENDOAVITENE™ preloaded applications, and SYRINGEAVITENE™ (Davol, Inc. (USA)); resorbable collagens, such as BIOBLANKET™ (Kensey Nash (USA)); recombinant human collagens; phase inverted biopolymers, such as POLIPHASE™ (Avalon Medical, Ltd.); fibrinogen and thrombin, such as HEMASEEL™ APR (Haemacure Corporation (Canada)), and FIBRX™ (Cryolife, Inc. (USA)); autologous processed plasma, such as ATELES™, CEBUS™, and PROTEUS™ (PlasmaSeal (USA)); polyethylene and polyurethane adhesive foams, such as those from Scapa Medical; rubber-based medical adhesives (Scapa Medical); aesthetic injectable adhesives, such as BIOHESIVE™ (Bone Solutions, Inc (USA); and others, including BAND-AIDS Brand Liquid Bandage Skin Crack Gel, THOREX™ from Surgical Sealants, Inc. (USA); and “aliphatic polyester macromers” as disclosed in US20060253094;
3. Primary wound dressings, for example, TEGADERM™ Ag Mesh, TEGADERM™ Ag Mesh With Silver, TEGADERM™ HI and HG Alginate Dressings, TEGADERM™ Hydrogel Wound Filler, TEGADERM™ Foam Adhesive and Non-Adhesive Dressings, COBAN™ Self-Adherent Wrap, CAVILON™ No-Sting Barrier Film, available from 3M (USA);
4. Surgical closure tape, such as STERI-STRIP™ S Surgical Skin Closure Tape and MEDIPORE™ H Soft Cloth Surgical Tape from 3M (USA);
5. Hemostats, in the form of topical applications, such as various forms of thrombin; matrix applications, such as bovine thrombin with cross-linked gelatin granules (FLOSEAL™ from Baxter International); sheets, such as AVITENE™ microfibrillar collagen from Davol, Inc. (USA); gauze, such as BLOODSTOP™ and BLOODSTOP™ iX (LifesciencePlus (USA)), and ActCel (ActSys Medical (USA)); gelatin sponge, such as GELFOAM™; collagen sponge, such as ULTRAFOAM™ (Davol, Inc. (USA)); lyophilized collagen sponge, such as INSTAT™ (Ethicon, Inc. (USA)); and oxidized regenerated cellulose, such as OXYCEL™ and SURGICEL™ (Ethicon, Inc. (USA))
6. Dental pit and fissure sealants, and luting cements.

Application of the materials of this invention in polymer-wood composites is also contemplated. With the rising cost of wood and the shortage of mature trees, there is a need to find good quality substitutes for wood that are more durable and longer-lasting (less susceptible to termite destruction and wood rot). Over the past several years, a growing market has emerged for the use of polymer-wood composites to replace traditional solid wood products in end-use applications such as extruded and foam-filled extruded building and construction materials (such as window frames, exterior cladding, exterior siding, door frames, ducting, roof shingles and related roofline products, and exterior boardwalks and walkways); interiors and internal finishes (for example, interior paneling, decorative profiles, office furniture, kitchen cabinets, shelving, worktops, blinds and shutters, skirting boards, and interior railings); automotive (including door and head liners, ducting, interior panels, dashboards, rear shelves, trunk floors, and spare tire covers); garden and outdoor products (such as decking, fence posts and fencing, rails and railings, garden furniture, sheds and shelters, park benches, playground equipment, and playground surfaces); and finally, industrial applications (including industrial flooring, railings, marine pilings, marine bulkheads, fishing nets, railroad ties, pallets, etc.). Polymer-wood composites also offer anti-sapstain protection.

Polymer-wood composites may vary widely in composition, with polymer content typically ranging from about 3-80% by weight depending on end-use. Injection molded products require adequate flow of the molten material; and therefore, preferably contain from about 65 to 80% by weight of the polymer component. Whereas composites requiring structural strength may typically contain only about 3-20% polymer by weight, the polymer typically serving primarily as an adhesive. Perhaps the most commonly employed polymer components are the polyolefins (polyethylene or polypropylene, high density and low density versions and mixtures thereof), although polybutene, polystyrene, and other polymers with melting temperatures between about 130°-200° C. are also used. In principal, any polymer with a melt temperature below the decomposition temperature of the cellulosic fiber component may be employed. Crosslinking chemicals (such as peroxides and vinylsilanes), compatibilizers and coupling agents (such as grafted-maleic anhydride polymers or copolymers) that incorporate functionality capable of forming covalent bonds within or between the polymer and cellulosic components may be included. Cellulosic materials can be obtained from a wide variety of sources: wood and wood products, such as wood pulp fibers; non-woody paper-making fibers from cotton; straws and grasses, such as rice and esparto; canes and reeds, such as bagasse; bamboos; stalks with bast fibers, such as jute, flax, kenaf, cannabis, linen and ramie; and leaf fibers, such as abaca and sisal; paper or polymer-coated paper including recycled paper and polymer-coated paper. One or more cellulosic materials can be used. More commonly, the cellulosic material used is from a wood source. Suitable wood sources include softwood sources such as pines, spruces, and firs, and hardwood sources such as oaks, maples, eucalyptuses, poplars, beeches, and aspens. The form of the cellulosic materials from wood sources can be sawdust, wood chips, wood flour, or the like. Still, microbes such as bacteria and fungus can feed on plasticizers or other additives and environmental foodstuffs found in or on the polymer component, resulting in discoloration and structural (chemical or mechanical) degradation. The present invention provides a means to more effectively address these issues by incorporating silver-based antimicrobial or antiviral agents in the polymer and/or wood component of these composites without compromising the color of the final object.

Another emerging application to which the present invention is particularly applicable is antimicrobial nonwoven fabrics, textiles that are neither woven nor knit. Nonwoven fabric is typically manufactured by putting small fibers together in the form of a sheet or web, and then binding them either mechanically (as in the case of felt, by interlocking them with serrated needles such that the inter-fiber friction results in a stronger fabric), with an adhesive, or thermally (by applying binder (in the form of powder, paste, or polymer melt) and melting the binder onto the web by increasing the temperature, or by thermal spot bonding). Nonwovens are often classified as either durable or single-use (disposable), depending on the end-use application.

Staple nonwovens are made in two steps. Fibers are first spun, cut to a few centimeters length, and put into bales. These bales are then dispersed on a conveyor belt, and the fibers are spread in a uniform web by a wetlaid process or by carding. Wetlaid operations typically use ¼″ to ¾″ long fibers, but sometimes longer if the fiber is stiff or thick. Carding operations typically use ˜1.5″ long fibers. Fiberglass may be wetlaid into mats for use in roofing and shingles. Synthetic fiber blends are wetlaid along with cellulose for single-use fabrics. Staple nonwovens are bonded throughout the web by resin saturation or overall thermal bonding or in a distinct pattern via resin printing or thermal spot bonding. Coforming with staple fibers usually refers to a combination with meltblown, often used in high-end textile insulations.

Spunlaid nonwovens are made in one continuous process. Fibers are spun and then directly dispersed into a web by deflectors or directed with air streams. This technique leads to faster belt speeds, and lower cost. Several variants of this concept are commercially available, a leading technology is the Reicofil machinery, manufactured by Reifenhauser (Germany). In addition, spunbond has been combined with meltblown nonwovens, coforming them into a layered product called SMS (spun-melt-spun). Meltblown nonwovens have extremely fine fiber diameters but are not strong fabrics. SMS fabrics, made completely from polypropylene are water-repellent and fine enough to serve as disposable fabrics. Meltblown nonwovens are often used as filter media, being able to capture very fine particles.

In other processes, nonwovens may start from films and fibrillate, serrate or vacuum-formed shapes made with patterned holes. The spunlace process achieves mechanical intertwining of the nonwoven fibers by the use water jets (hydro-entanglement). Ultrasonic pattern bonding is often used in high-loft or fabric insulation/quilts/bedding. In an unusual process, nonwoven housewrap (e.g. DuPont TYVEK™) utilizes polyethylene fibrils in a Freon-like fluid, forming and calendering them into a paper-like product; while spunbound polypropylene (e.g. DuPont TYPAR™) is used in carpet backing, packaging, construction (roof and housewrap) and geotextile applications.

Fiberglass nonwovens are of two basic types. Wet laid mat or “glass tissue” use wet-chopped, heavy denier fibers in the 6 to 20 micrometer diameter range. Flame attenuated mats or “batts” use discontinuous fine denier fibers in the 0.1 to 6 micrometer range. The latter is similar, though run at much higher temperatures, to meltblown thermoplastic nonwovens. Wet laid mat is almost always wet resin bonded with a curtain coater, whereas batts are usually spray bonded with wet or dry resin.

The use of natural fibers such as cellulose in nonwovens (e.g. nonwoven cotton mesh gauze available as TEGADERM™, and nonwoven rayon available as BEMLIESE™) has largely given way to man-made fibers such as the polyolefins, polyamides and polyester (mostly PET). PET-based nonwovens are superior in resiliency, wrinkle recovery and comfort when in contact with the skin, as well as in high temperature performance. Applications for polyester (as well as polyethylene and polypropylene) nonwovens include medical (such as isolation caps, gowns, covers and masks; surgical drapes, gowns and scrub suits) hygiene (baby diapers, feminine hygiene, adult incontinence products, wipes, bandages and wound dressings), filters (gasoline, oil and air—including HEPA filtration, water, pool and spa, coffee and tea bags) geotextiles (soil stabilizers and roadway underlayment, agricultural mulch, pond and canal barriers, and sand filtration barriers for drainage tiles) technical (ceiling tile facings, circuit board reinforcement, electrical insulation, insulation backing, honeycomb structural components, roll roofing and shingle reinforcement, wall coverings, vinyl flooring reinforcement and plastic surface reinforcement (veils)) and miscellaneous (carpet backing, marine sail and tabletop laminates, backing/stabilizer for machine embroidery, fiberglass batting insulation, pillows, cushions and upholstery padding, and batting in quilts or comforters). Commercial offerings useful for wound dressings include, for example, perforated, non-adherent non-woven meshes such as; DELNET™ P530, which is a non-woven veil formed of high density polyethylene using extrusion, embossing and orientation processes, produced by Applied Extrusion Technologies, Inc. of Middletown, Del., USA. This same product is available as Exu-Dry CONFORMANT 2™ wound veil, from Frass Survival Systems. Inc., Bronx, N.Y., USA as a subset of that company's Wound Dressing Roll (Non-Adherent) products. Other useful non-woven meshes include CARELLE™ available from Carolina Formed Fabrics Corp., USA, and N-TERFACE™ available from Winfield Laboratories, Inc., of Richardson, Tex., USA.

Nylon is also excellent in high temperature applications, but its use in nonwovens is more limited due to its high cost relative to rayon, polyolefins and polyesters; and reduced comfort relative to polyesters when used as a textile. Nonetheless, nylon is used as a blending fiber in athletic wear, nonwoven garment linings and in wipes because it imparts excellent tear strength (commercial offerings include, for example, NYLON 90™ available from Carolina Formed Fabrics Corporation (USA)). Nylon is often used in surface conditioning abrasives wherein abrasive grains are adhered with resin to the internal fiber surfaces of a nonwoven nylon backing/support. Tools containing such an abrasive/nylon system take the form of nonwoven pads, nonwoven wheels, nonwoven sheets & rolls, surface conditioning discs, convolute wheels, unified or unitized wheels and flap nonwoven wheels. Nonwoven nylon is also used as an electrode separator in Ni/H and Ni/Cd batteries. An unusual specialty spunbond nylon (CEREX™) is self-bonded by a gas-phase acidification process.

Nonwoven substrates composed of multiple fiber types, including both natural and synthetic fiber materials, may be used in the present invention. Commercial offerings of such blended nonwoven layer materials have included SONTARA™ 8868, a hydro-entangled material, containing about 50/50 cellulose/polyester, and SONTARA™ 8411, a 70/30 rayon/polyester blend commercially available from Dupont Canada, Mississauga, Ontario, Canada; HFE-40-047, an apertured hydro-entangled material containing about 50% rayon and 50% polyester; and NOVENET™ 149-191, a thermo-bonded grid patterned material containing about 69% rayon, about 25% polypropylene, and about 6% cotton, both of the latter from Veratec, Inc., Walpole, Mass. (USA); and KEYBAK™ 951V, a dry formed apertured material, containing about 75% rayon and about 25% acrylic fibers from Chicopee Corporation, New Brunswick, N.J. (USA).

In contrast to staple nonwoven fabrics that that employ short fibers of only a few centimeters in length, continuous filament nonwoven fabrics are formed by supplying a low viscosity molten polymer that is then extruded under pressure through a large number of micro-orifices in a plate known as a spinneret or die, which creates a plurality of continuous polymeric filaments. The filaments are then quenched and drawn, and collected to form a nonwoven web. Extrusion of melt polymers through micro-orifices requires that polymer additives have particle sizes significantly smaller than the orifice diameter. It is preferred that the additive particles be less than a quarter of the diameter of the orifice holes to avoid process instabilities such as filament breakage and entanglement, or “roping”, of filaments while still in the molten state. Microfilaments may typically be on the order of about 20 microns in diameter, while super microfilaments may be on the order of 3-5 microns or less. Continuous filament nonwoven fabrics formed from super microfilaments are mainly used in air filters, as well as in artificial leathers and wipes. Commercial processes are well known in the art for producing continuous microfilament nonwoven fabrics of many polymers (e.g. polyethylene, polypropylene, polyester, rayon, polyvinyl acetate, acrylics, nylon). Splittable microfibers of 2-3 micron or less diameter are readily processable on nonwoven textile equipment (carded, airlaid, wetlaid, needlepunch and hydro-entanglement). The present invention enables production of melt-processed polymers comprising silver-based antimicrobial agents that may then be efficiently incorporated into such fine diameter filaments with greatly reduced discoloration.

The following examples are intended to demonstrate, but not to limit, the invention.

### EXAMPLES

### Example 1

This example examines the color of melt-processed polypropylene composites containing silver sulfate precipitated in the presence of the grain-size reducing additive sodium dodecylsulfate (SDS), and further containing an additional additive introduced into the precipitation reactor prior to the final washing and drying steps.

Preparation of Silver Sulfate Sample 1-A: Comparative with No Additive

A six-liter stainless steel sponge kettle was charged with 2 L of distilled water and the temperature controlled at 40° C. A planar mixing device previously described (Research Disclosure 38213, February 1996 pp 111-114 “Mixer for Improved Control Over Reaction Environment”) operating at 3000 rpm was used to ensure the homogeneity of the reactor contents. To this reactor 71.2 mL of a 3.6M solution of ammonium sulfate and 100 mL of a solution containing 0.17 g sodium dodecylsulfate (SDS) was added. Peristaltic pumps were used to simultaneously deliver a 640 mL solution containing 3.1M silver nitrate at a rate of 225.0 mL/min, a 333 mL solution containing 2.9M ammonium sulfate at a rate of 117.1 mL/min and a 67 mL solution containing 0.83 g SDS at a rate of 23.6 mL/min causing precipitation of a white product. The reaction was held at 40° C. for 5 min. The final product was washed to a conductivity of <10 mS and a portion dried at ambient temperature for 24 h followed by further drying for 1 h at 100° C. Powder X-ray diffraction confirmed the product was single-phase silver sulfate.

Preparation of Silver Sulfate Sample 1-B: Comparative with Ammonium Sulfate Additive

A six-liter stainless steel sponge kettle was charged with 2 L of distilled water and the temperature controlled at 40° C. The reactor contents were mixed as described in Sample 1-A. To this reactor 71.2 mL of a 3.6M solution of ammonium sulfate and 100 mL of a solution containing 0.17 g sodium dodecylsulfate (SDS) was added. Peristaltic pumps were used to simultaneously deliver a 640 mL solution containing 3.1M silver nitrate at a rate of 225.0 mL/min, a 333 mL solution containing 2.9M ammonium sulfate at a rate of 117.1 mL/min and a 67 mL solution containing 0.83 g SDS at a rate of 23.6 mL/min causing precipitation of a white product. The reaction was held at 40° C. for 5 min after which a peristaltic pump delivered a 67 mL solution containing 2 g ammonium sulfate at a rate of 6.7 mL/min. The reaction was held at 40° C. for 5 min. The final product was washed to a conductivity of <10 mS and a portion dried at ambient temperature for 24 h followed by further drying for 1 h at 100° C.

Preparation of Silver Sulfate Sample 1-C: Comparative with Sodium Tungstate Additive

A six-liter stainless steel sponge kettle was charged with 2 L of distilled water and the temperature controlled at 40° C. The reactor contents were mixed as described in Sample 1-A. To this reactor 71.2 mL of a 3.6M solution of ammonium sulfate and 100 mL of a solution containing 0.17 g sodium dodecylsulfate (SDS) was added. Peristaltic pumps were used to simultaneously deliver a 640 mL solution containing 3.1M silver nitrate at a rate of 225.0 mL/min, a 333 mL solution containing 2.9M ammonium sulfate at a rate of 117.1 mL/min and a 67 mL solution containing 0.83 g SDS at a rate of 23.6 mL/min causing precipitation of a white product. The reaction was held at 40° C. for 5 min after which a peristaltic pump delivered a 67 mL solution containing 3 g sodium tungstate at a rate of 6.7 mL/min. The reaction was held at 40° C. for 5 min. The final product was washed to a conductivity of <10 mS and a portion dried at ambient temperature for 24 h followed by further drying for 1 h at 100° C.

Preparation of Silver Sulfate Sample 1-D: Comparative with Sodium Chlorite Additive

A six-liter stainless steel sponge kettle was charged with 2 L of distilled water and the temperature controlled at 40° C. The reactor contents were mixed as described in Sample 1-A. To this reactor 71.2 mL of a 3.6M solution of ammonium sulfate and 100 mL of a solution containing 0.17 g sodium dodecylsulfate (SDS) was added. Peristaltic pumps were used to simultaneously deliver a 640 mL solution containing 3.1M silver nitrate at a rate of 225.0 mL/min, a 333 mL solution containing 2.9M ammonium sulfate at a rate of 117.1 mL/min and a 67 mL solution containing 0.83 g SDS at a rate of 23.6 mL/min causing precipitation of a white product. The reaction was held at 40° C. for 5 min after which a peristaltic pump delivered a 67 mL solution containing 2 g sodium chlorite at a rate of 6.7 mL/min. The reaction was held at 40° C. for 5 min. The final product was washed to a conductivity of <10 mS and a portion dried at ambient temperature for 24 h followed by further drying for 1 h at 100° C.

Preparation of Silver Sulfate Sample 1-E: Inventive with Potassium Iodate Additive (0.1 g)

A six-liter stainless steel sponge kettle was charged with 2 L of distilled water and the temperature controlled at 40° C. The reactor contents were mixed as described in Sample 1-A. To this reactor 71.2 mL of a 3.6M solution of ammonium sulfate and 100 mL of a solution containing 0.17 g sodium dodecylsulfate (SDS) was added. Peristaltic pumps were used to simultaneously deliver a 640 mL solution containing 3.1M silver nitrate at a rate of 225.0 mL/min, a 333 mL solution containing 2.9M ammonium sulfate at a rate of 117.1 mL/min and a 67 mL solution containing 0.83 g SDS at a rate of 23.6 mL/min causing precipitation of a white product. The reaction was held at 40° C. for 5 min after which a peristaltic pump delivered a 67 mL solution containing 0.1 g potassium iodate at a rate of 6.7 mL/min. The reaction was held at 40° C. for 5 min. The final product was washed to a conductivity of <10 mS and a portion dried at ambient temperature for 24 h followed by further drying for 1 h at 100° C.

Preparation of Silver Sulfate Sample 1-F: Inventive with Potassium Iodate Additive (0.5 g)

A six-liter stainless steel sponge kettle was charged with 2 L of distilled water and the temperature controlled at 40° C. The reactor contents were mixed as described in Sample 1-A. To this reactor 71.2 mL of a 3.6M solution of ammonium sulfate and 100 mL of a solution containing 0.17 g sodium dodecylsulfate (SDS) was added. Peristaltic pumps were used to simultaneously deliver a 640 mL solution containing 3.1M silver nitrate at a rate of 225.0 mL/min, a 333 mL solution containing 2.9M ammonium sulfate at a rate of 117.1 mL/min and a 67 mL solution containing 0.83 g SDS at a rate of 23.6 mL/min causing precipitation of a white product. The reaction was held at 40° C. for 5 min after which a peristaltic pump delivered a 67 mL solution containing 0.5 g potassium iodate at a rate of 6.7 mL/min. The reaction was held at 40° C. for 5 min. The final product was washed to a conductivity of <10 mS and a portion dried at ambient temperature for 24 h followed by further drying for 1 h at 100° C.

Preparation of Silver Sulfate Sample 1-G: Inventive with Potassium Iodate Additive Added Before Silver Addition

A six-liter stainless steel sponge kettle was charged with 2 L of distilled water and the temperature controlled at 40° C. The reactor contents were mixed as described in Sample 1-A. To this reactor 71.2 mL of a 3.6M solution of ammonium sulfate, 100 mL of a solution containing 0.17 g sodium dodecylsulfate (SDS) and 100 mL of a solution containing 2 g potassium iodate was added. Peristaltic pumps were used to simultaneously deliver a 640 mL solution containing 3.1M silver nitrate at a rate of 225.0 mL/min, a 333 mL solution containing 2.9M ammonium sulfate at a rate of 117.1 mL/min and a 67 mL solution containing 0.83 g SDS at a rate of 23.6 mL/min causing precipitation of a white product. The reaction was held at 40° C. for 5 min. The final product was washed to a conductivity of <10 mS and a portion dried at ambient temperature for 24 h followed by further drying for 1 h at 100° C.

Preparation of Silver Sulfate Sample 1-H: Inventive with Potassium Iodate Additive Added During Silver Addition

A six-liter stainless steel sponge kettle was charged with 2 L of distilled water and the temperature controlled at 40° C. The reactor contents were mixed as described in Sample 1-A. To this reactor 71.2 mL of a 3.6M solution of ammonium sulfate and 100 mL of a solution containing 0.17 g sodium dodecylsulfate (SDS) was added. Peristaltic pumps were used to simultaneously deliver a 640 mL solution containing 3.1M silver nitrate at a rate of 225.0 mL/min, a 333 mL solution containing 2.9M ammonium sulfate at a rate of 117.1 mL/min, a 67 mL solution containing 0.83 g SDS at a rate of 23.6 mL/min and a 67 mL solution containing 2.0 g potassium iodate at a rate of 23.6 mL/min causing precipitation of a white product. The reaction was held at 40° C. for 5 min. The final product was washed to a conductivity of <10 mS and a portion dried at ambient temperature for 24 h followed by further drying for 1 h at 100° C.

Preparation of Silver Sulfate Sample 1-I: Inventive with Potassium Iodate Additive Added after Silver Addition

A six-liter stainless steel sponge kettle was charged with 2 L of distilled water and the temperature controlled at 40° C. The reactor contents were mixed as described in Sample 1-A. To this reactor 71.2 mL of a 3.6M solution of ammonium sulfate and 100 mL of a solution containing 0.17 g sodium dodecylsulfate (SDS) was added. Peristaltic pumps were used to simultaneously deliver a 640 mL solution containing 3.1M silver nitrate at a rate of 225.0 mL/min, a 333 mL solution containing 2.9M ammonium sulfate at a rate of 117.1 mL/min and a 67 mL solution containing 0.83 g SDS at a rate of 23.6 mL/min causing precipitation of a white product. The reaction was held at 40° C. for 5 min after which a peristaltic pump delivered a 67 mL solution containing 2 g potassium iodate at a rate of 6.7 mL/min. The reaction was held at 40° C. for 5 min. The final product was washed to a conductivity of <10 mS and a portion dried at ambient temperature for 24 h followed by further drying for 1 h at 100° C.

Preparation of Silver Sulfate Sample 1-J: Inventive with (3 g) SDS and with Potassium Iodate Additive

A six-liter stainless steel sponge kettle was charged with 2 L of distilled water and the temperature controlled at 40° C. The reactor contents were mixed as described in Sample 1-A. To this reactor 71.2 mL of a 3.6M solution of ammonium sulfate and 100 mL of a solution containing 0.51 g sodium dodecylsulfate (SDS) was added. Peristaltic pumps were used to simultaneously deliver a 640 mL solution containing 3.1M silver nitrate at a rate of 225.0 mL/min, a 333 mL solution containing 2.9M ammonium sulfate at a rate of 117.1 mL/min and a 67 mL solution containing 2.49 g SDS at a rate of 23.6 mL/min causing precipitation of a white product. The reaction was held at 40° C. for 5 min after which a peristaltic pump delivered a 67 mL solution containing 2 g potassium iodate at a rate of 6.7 mL/min. The reaction was held at 40° C. for 5 min. The final product was washed to a conductivity of <10 mS and a portion dried at ambient temperature for 24 h followed by further drying for 1 h at 100° C.

Preparation of Silver Sulfate Sample 1-K: Inventive with Sodium Bromate Additive

A six-liter stainless steel sponge kettle was charged with 2 L of distilled water and the temperature controlled at 40° C. The reactor contents were mixed as described in Sample 1-A. To this reactor 71.2 mL of a 3.6M solution of ammonium sulfate and 100 mL of a solution containing 0.17 g sodium dodecylsulfate (SDS) was added. Peristaltic pumps were used to simultaneously deliver a 640 mL solution containing 3.1M silver nitrate at a rate of 225.0 mL/min, a 333 mL solution containing 2.9M ammonium sulfate at a rate of 117.1 mL/min and a 67 mL solution containing 0.83 g SDS at a rate of 23.6 mL/min causing precipitation of a white product. The reaction was held at 40° C. for 5 min after which a peristaltic pump delivered a 67 mL solution containing 2 g sodium bromate at a rate of 6.7 mL/min. The reaction was held at 40° C. for 5 min. The final product was washed to a conductivity of <10 mS and a portion dried at ambient temperature for 24 h followed by further drying for 1 h at 100° C.

Preparation of Silver Sulfate Sample 1-L: Comparative with Sodium Bromate Additive (15 g)

A six-liter stainless steel sponge kettle was charged with 2 L of distilled water and the temperature controlled at 40° C. The reactor contents were mixed as described in Sample 1-A. To this reactor 71.2 mL of a 3.6M solution of ammonium sulfate and 100 mL of a solution containing 0.17 g sodium dodecylsulfate (SDS) was added. Peristaltic pumps were used to simultaneously deliver a 640 mL solution containing 3.1M silver nitrate at a rate of 225.0 mL/min, a 333 mL solution containing 2.9M ammonium sulfate at a rate of 117.1 mL/min and a 67 mL solution containing 0.83 g SDS at a rate of 23.6 mL/min causing precipitation of a white product. The reaction was held at 40° C. for 5 min after which a peristaltic pump delivered a 67 mL solution containing 15 g sodium bromate at a rate of 6.7 mL/min. The reaction was held at 40° C. for 5 min. The final product was washed to a conductivity of <10 mS and a portion dried at ambient temperature for 24 h followed by further drying for 1 h at 100° C.

Polypropylene composites containing 2.5 weight percent of the silver sulfate samples of Example 1 were prepared by the following procedure. A Brabender paddle compounder was preheated to 220° C. and the mixing paddles were set to 60 rpm. Into the feed chamber was charged 39.0 g of Huntsman Polypropylene P4C6Z-049, and compounded 2 min under a dry nitrogen purge. Following the melting of the polypropylene, 1.0 g of silver sulfate powder (from Samples 1-A through 1-L) was added to the feed chamber and the composite was compounded 4 min under a nitrogen purge. The mixing paddles were stopped, and the feed chamber was dismantled. The compounded sample was removed from the chamber walls and paddles, and a composite plaque was produced by pressing the compounded sample onto a stainless steel plate at a temperature of 22° C.

The color of the composite plaques described above was quantified by measuring the spectral response in a HunterLab UltraScan XE colorimeter. Color is reported in terms of the 1976 CIE a* and b* coordinates, wherein L* is a measure of lightness-darkness (L*=100 equals a pure white, L*=0 equals black), a* is a measure of the redness or greenness of the plaque, and b* is a measure of the yellowness or blueness of the plaque. Values of a* and b* that are closer to zero represent a less colored composite. Further description of the colorimetric test procedure is contained in Billmeyer, F. W., et al., Principles of Color Technology, 2^{nd} Edition, pp. 62-64, published by John Wiley & Sons, Inc., 1981; or in ASTM Designations: D 2244-05 and D 1729-96.

Quantitative color measurements for polypropylene composites containing 2.5 weight percent of the silver sulfate samples of Example 1 are shown in Table 1 below. Relative color metrics are defined as the difference between the L*, a* and b* values of a sample plaque and those of a pure polypropylene plaque to which no silver sulfate was added. A positive delta L* (DL*) represents a whiter sample, whereas a negative DL* represents a grayer sample relative to pure polypropylene. Thermal yellowing is a problem, in general, for melt-processed polymers, and is represented by a positive delta b* (Db*) value. Reduced discoloration in the form of less thermal yellowing is embodied, in general, in a less positive Db* value. A preferred color position for heat-processed polymers is often a less positive Db* value. A more preferred color position is typically a less positive Db* value and a Da* value closer to zero. A still more preferred position is a less positive Db* value, along with a Da* value closer to zero and a larger DL* value, as this represents a less yellow, less colored and less gray position.

TABLE 1

| | Size Control | | | | | | | |
|---|---|---|---|---|---|---|---|---|
| | Additive | | Color Control Additive | | | Relative | | |
| Sample | | Amount | | Amount | Addition | Color Metrics | | |
| No. | Compound | (mol %) | Compound | (mol %) | Point | DL* | Da* | Db* |
| 1-A | SDS | 0.35 | none | — | — | 2.4 | 7.2 | 29.7 |
| Comp. | | | | | | | | |
| 1-B | SDS | 0.35 | ammonium sulfate | 1.52 | After silver | −0.8 | 3.1 | 24.0 |
| Comp. | | | | | | | | |
| 1-C | SDS | 0.35 | sodium tungstate | 1.02 | After silver | −14.5 | 13.4 | 18.3 |
| Comp. | | | | | | | | |
| 1-D | SDS | 0.35 | sodium chlorite | 2.21 | After silver | 3.1 | 8.5 | 32.7 |
| Comp. | | | | | | | | |
| 1-E | SDS | 0.35 | potassium iodate | 0.05 | After silver | 4.2 | 5.2 | 24.8 |
| Inv. | | | | | | | | |
| 1-F | SDS | 0.35 | potassium iodate | 0.23 | After silver | 13.4 | 3.6 | 15.7 |
| Inv. | | | | | | | | |
| 1-G | SDS | 0.35 | potassium iodate | 0.93 | Before silver | 6.4 | 1.0 | 8.4 |
| Inv. | | | | | | | | |
| 1-H | SDS | 0.35 | potassium iodate | 0.93 | With silver | 8.7 | 1.0 | 8.1 |
| Inv. | | | | | | | | |
| 1-I | SDS | 0.35 | potassium iodate | 0.93 | After silver | 3.4 | 1.3 | 10.0 |
| Inv. | | | | | | | | |
| 1-J | SDS | 1.04 | potassium iodate | 0.93 | After silver | 5.4 | 4.9 | 18.2 |
| Inv. | | | | | | | | |
| 1-K | SDS | 0.35 | sodium bromate | 1.33 | After silver | 6.7 | 2.8 | 20.5 |
| Inv. | | | | | | | | |
| 1-L | SDS | 0.35 | sodium bromate | 9.94 | After silver | 4.2 | 4.2 | 25.5 |
| Inv. | | | | | | | | |

Consideration of the relative color metrics given above for Sample 1-A establishes the degree of discoloration imparted by compounding polypropylene with 2.5 weight percent of silver sulfate precipitated in the presence of 0.35 molar percent of sodium dodecylsulfate (SDS), a grain size control agent. The plaque containing Sample 1-A is yellow-brown in appearance. Comparison of the results for Sample 1-B to Sample 1-A indicates that while Da* and Db* are reduced (less color), DL* is also reduced (more gray), indicating that additional ammonium sulfate additive leads to an altered but not substantially improved appearance. Results from Sample 1- C for sodium tungstate additive indicate a shift in color and a severe darkening (greatly reduced DL*) of the plaque. Results from Sample 1-D for sodium chlorite additive indicate slightly more discoloration along with less gray, overall not a substantial change in appearance relative to Sample 1-A. Results for Samples 1-E, 1-F, 1-H and 1-I represent an increasing level of potassium iodate added after the silver nitrate addition, and a dramatice reduction in discoloration (less positive Da* and less positive Db*) and an increase in whiteness (larger DL*) results. Results for Samples 1-G and 1-H show a similarly dramatic reduction in discoloration and increased whiteness, indicating that the efficacy of the potassium iodate additive may be even greater when the additive is added prior to or along with the silver nitrate. Comparison of the results for Sample 1-J to 1-I indicate that while a 3 fold increase in the grain-size controlling SDS additive amount leads to more discoloration, the potassium iodate additive of the invention is still substantially effective in reducing discoloration relative to the no additive position of Sample 1-A. Comparison of the results for Samples 1-K and 1-L indicate that sodium bromate additive affords substantial reductions in discoloration (less positive Da* and less positive Db*) and increases in whiteness (larger DL*) relative to the no additive position of Sample 1-A.

### Example 2

This example demonstrates the utility of the sodium salt of the iodate additive of the invention in an alternative precipitation scheme for silver sulfate.

Preparation of Silver Sulfate Sample 2-A: Inventive with Sodium Iodate Additive

An eighteen-liter stainless steel sponge kettle was charged with 8 L of a 4.3M solution of ammonium sulfate and the temperature controlled at 15° C. The reactor contents were mixed as described in Sample 1-A but the mixer speed was increased to 5000 rpm. To this reactor 500.0 mL of a solution containing 60.0 g sodium dodecylsulfate (SDS) was added. A peristaltic pump was used to deliver a 8064 mL solution containing 5.7M silver nitrate at a rate of 225.0 mL/min causing precipitation of a white product. The reaction was held at 15° C. for 10 min after which a peristaltic pump delivered a 500.0 mL solution containing 24 g sodium iodate at a rate of 100 mL/min. The reaction was held at 15° C. for 15 min. The final product was washed to a conductivity of <10 mS and a portion dried at ambient temperature for 24 h followed by further drying for 1 h at 100° C.

A polypropylene composite containing 5.0 weight percent of silver sulfate Sample 2-A was prepared by the following procedure. A Leistritz twin-screw compounder with 10 zones was preheated to 200° C. and the screw speed was set to 200 rpm. Into the feed position at zone 1, was charged Huntsman Polypropylene P4C6Z-049 fed at a rate of 28.5 pounds per hour using a single-screw pellet feeder. Following the melting of the polypropylene, silver sulfate powder of Sample 2-A was fed at a rate of 1.5 pounds per hour into the feed position at zone 4 using a twin-screw side port feeder. All mixing, melting, and compounding occurred in ambient air. The resulting composite was extruded as 4 strands and quenched to room temperature (22° C.) using a flowing water bath. The resulting solid strands were fed into a multiblade chopper, generating composite pellets (approximately 1 cm by 2 cm in size).

A composite plaque was produced from pellets using a Carver Press preheated to 182° C. A sandwich was made by placing an aliquot of pellets between two polyimide polymer sheets. This sandwich was placed on the Carver Press platens, followed by bringing the platens together, melting the composite pellets, resulting in a plaque between the polyimide sheets. The sandwich was removed from the Carver Press, and the sandwich was quenched at room temperature (22° C.) between two metal plates. The polyimide sheets were peeled away, leaving a freestanding composite plaque.

The color of the composite plaque was quantified by the procedures described in Example 1 above. Relative color metrics of 10.95 DL*, 0.94 Da* and 4.18 Db* indicate that a similarly excellent color and whiteness position can be achieved with sodium iodate additive.

### Example 3

This example examines the color of melt-processed polypropylene in which the color controlling additive potassium iodate was introduced into the polypropylene prior to the addition of the silver sulfate that was precipitated in the presence of the grain-size reducing additive sodium dodecylsulfate (SDS).

A Brabender paddle compounder was preheated to 220° C. and the mixing paddles were set to 60 rpm. Into the feed chamber was charged 38.9 g of Huntsman Polypropylene P4C6Z-049, and compounded 2 min under a dry nitrogen purge. Following the melting of the polypropylene, 0.1 g of KlO₃ was added to the feed chamber and compounded 0.5 min under a dry nitrogen purge. Subsequently, 1.0 g of silver sulfate powder (Sample 1-A) was added to the feed chamber and the composite was compounded 4 min under a dry nitrogen purge. The mixing paddles were stopped, and the feed chamber was dismantled. The compounded sample was removed from the chamber walls and paddles, and a composite plaque called Sample 3 was produced by pressing the compounded sample onto a stainless steel plate at a temperature of 22° C.

The color of the composite plaque Sample 3 was quantified by the procedures described in Example 1 above. Relative color metrics are given in the table below:

| | Size Control | | | | | | | |
|---|---|---|---|---|---|---|---|---|
| | Additive | | Color Control Additive | | | Relative | | |
| Sample | | Amount | | Amount | | Color Metrics | | |
| No. | Compound | (mol %) | Compound | (mol %) | Addition Point | DL* | Da* | Db* |
| 1-A | SDS | 0.35 | None | — | — | 2.4 | 7.2 | 29.7 |
| Comp. | | | | | | | | |
| 3 | SDS | 0.35 | potassium iodate | 14.57 | During | 12.8 | 3.7 | 25.0 |
| Inv. | | | | | compounding, | | | |
| | | | | | prior to | | | |
| | | | | | silver sulfate | | | |
| | | | | | addition | | | |

Comparison of the relative color metrics for composite plaque Sample 3 and the no additive comparison prepared using silver sulfate Sample 1-A in Example 1 above, indicates that a significant increase in whiteness (DL*) and a substantial decrease in coloration (Da* abd Db*) can be obtained by compounding potassium iodate into the melt-processed polypropylene prior to the addition of silver sulfate precipitated in the presence of the grain-size reducing additive sodium dodecylsulfate. We note, however, that from a discoloration reduction perspective, a much larger amount of potassium iodate additive (14.57 molar percent relative to silver sulfate) is required by this precompounding process to reduce the yellowness to 25 Db* relative to the amount of potassium iodate additive (0.05 molar percent relative to silver sulfate) required to obtain similar results when added during the precipitation process (see Sample 1-E in Example 1).

### Example 4

This example examines the color of melt-processed polypropylene composites containing silver sulfate precipitated in the presence of the grain-size reducing additive sodium dodecylbenzenesulfonate (DBS), and further containing potassium iodate additive of the invention that was introduced into the silver sulfate precipitation reactor prior to the final washing and drying steps.

Preparation of Silver Sulfate Sample 4-A: Comparative with No Additive

A six-liter stainless steel sponge kettle was charged with 2 L of distilled water and the temperature controlled at 40° C. The reactor contents were mixed as described in Example 1. To this reactor 71.2 mL of a 3.6M solution of ammonium sulfate and 100 mL of a solution containing 0.17 g sodium dodecylbenzenesulfonate (DBS) was added. Peristaltic pumps were used to simultaneously deliver a 640 mL solution containing 3.1M silver nitrate at a rate of 225.0 mL/min, a 333 mL solution containing 2.9M ammonium sulfate at a rate of 117.1 mL/min and a 67 mL solution containing 0.83 g DBS at a rate of 23.6 mL/min causing precipitation of a white product. The reaction was held at 40° C. for 5 min. The final product was washed to a conductivity of <10 mS and a portion dried at ambient temperature for 24 h followed by further drying for 1 h at 100° C.

Preparation of Silver Sulfate Sample 4-B: Inventive with Potassium Iodate Additive Added During Silver Addition

A six-liter stainless steel sponge kettle was charged with 2 L of distilled water and the temperature controlled at 40° C. The reactor contents were mixed as described in Example 1. To this reactor 71.2 mL of a 3.6M solution of ammonium sulfate and 100 mL of a solution containing 0.17 g sodium dodecylbenzenesulfonate (DBS) was added. Peristaltic pumps were used to simultaneously deliver a 640 mL solution containing 3.1M silver nitrate at a rate of 225.0 mL/min, a 333 mL solution containing 2.9M ammonium sulfate at a rate of 117.1 mL/min, a 67 mL solution containing 0.83 g DBS at a rate of 23.6 mL/min and a 67 mL solution containing 2.0 g potassium iodate at a rate of 23.6 mL/min causing precipitation of a white product. The reaction was held at 40° C. for 5 min. The final product was washed to a conductivity of <10 mS and a portion dried at ambient temperature for 24 h followed by further drying for 1 h at 100° C.

Polypropylene composites and composite plaques containing 2.5 weight percent of the silver sulfate samples of Example 4 were prepared by the procedures described in Example 1. The color of the composite plaques was quantified by the methods described in Example 1. Relative color metrics are given in the table below:

| | Size Control | | | | | | | |
|---|---|---|---|---|---|---|---|---|
| | Additive | | Color Control Additive | | | Relative | | |
| Sample | | Amount | | Amount | Addition | Color Metrics | | |
| No. | Compound | (mol %) | Compound | (mol %) | Point | DL* | Da* | Db* |
| 4-A | DBS | 0.29 | none | — | — | −5.6 | 11.9 | 33.1 |
| Comp. | | | | | | | | |
| 4-B | DBS | 0.29 | potassium iodate | 0.93 | With | −0.1 | 0.8 | 10.4 |
| Inv. | | | | | silver | | | |

### Example 5

This example examines the color of melt-processed polypropylene composites containing silver sulfate precipitated in the presence of grain-size reducing additive sodium polystyrene sulfonate (PSS), and further containing potassium iodate additive of the invention that was introduced into the silver sulfate precipitation reactor prior to the final washing and drying steps.

Preparation of Silver Sulfate Sample 5-A: Comparative with No Additive

An eighteen-liter stainless steel sponge kettle was charged with 5.5 L of distilled water and the temperature controlled at 40° C. A planar mixing device previously described (U.S. Pat. No. 6,422,736) operating at 3600 rpm was used to ensure the homogeneity of the reactor contents. To this reactor 427 mL of a 3.6M solution of ammonium sulfate and 100 mL of a solution containing 0.75 g sodium polystyrenesulfonate-70K MW (PSS) was added. Peristaltic pumps were used to simultaneously deliver a 3840 mL solution containing 3.1M silver nitrate at a rate of 225.0 mL/min, a 2000 mL solution containing 2.9M ammonium sulfate at a rate of 117.1 mL/min and a 400 mL solution containing 0.75 g PSS at a rate of 23.3 mL/min causing precipitation of a white product. The reaction was held at 40° C. for 5 min. The final product was washed to a conductivity of <10 mS and a portion dried at ambient temperature for 24 h followed by further drying for 4 h at 85° C.

Preparation of Silver Sulfate Sample 5-B: Inventive with Potassium Iodate Additive

An eighteen-liter stainless steel sponge kettle was charged with 5.5 L of distilled water and the temperature controlled at 40° C. The reactor contents were mixed as described in Sample 5-A above. To this reactor 427 mL of a 3.6M solution of ammonium sulfate and 100 mL of a solution containing 0.75 g sodium polystyrenesulfonate-70K MW (PSS) was added. Peristaltic pumps were used to simultaneously deliver a 3840 mL solution containing 3.1M silver nitrate at a rate of 225.0 mL/min, a 2000 mL solution containing 2.9M ammonium sulfate at a rate of 117.1 mL/min and a 400 mL solution containing 0.75 g PSS at a rate of 23.3 mL/min causing precipitation of a white product. The reaction was held at 40° C. for 5 min after which a peristaltic pump delivered a 400 mL solution containing 6 g potassium iodate at a rate of 40.0 mL/min. The reaction was held at 40° C. for 5 min. The final product was washed to a conductivity of <10 mS and a portion dried at ambient temperature for 24 h followed by further drying for 4 h at 85° C.

Polypropylene composites and composite plaques containing 5.0 weight percent of the silver sulfate samples of Example 5 were prepared by the procedures described in Example 2. The color of the composite plaques was quantified by the methods described in Example 1. Relative color metrics are given in the table below:

| | Size Control | | | | | | | |
|---|---|---|---|---|---|---|---|---|
| | Additive | | Color Control Additive | | | Relative | | |
| Sample | | Amount | | Amount | Addition | Color Metrics | | |
| No. | Compound | (mol %) | Compound | (mol %) | Point | DL* | Da* | Db* |
| 5-A | PSS | 0.02 | None | — | — | 7.6 | 0.8 | 3.7 |
| comp. | | | | | | | | |
| 5-B | PSS | 0.02 | potassium iodate | 0.47 | After | 2.6 | 0.1 | 1.8 |
| Inv. | | | | | silver | | | |

Comparison of the relative color metrics shown above indicates that the mild discoloration (positive Da* and Db*) induced by melt-processing polypropylene with silver sulfate precipitated in the presence of the grain-size reducing additive sodium polystyrenesulfonate, can be reduced by including the potassium iodate additive of the invention in the silver sulfate precipitation reactor prior to the final washing and drying steps.

### Example 6

This example examines the color of melt-processed PET composites containing silver sulfate precipitated in the presence of grain-size reducing sodium polystyrene sulfonate (PSS) additive, and further containing a color controlling additive introduced into the precipitation reactor prior to the final washing and drying steps.

Preparation of Silver Sulfate Sample 6-A: Comparative with No Additive

An eighteen-liter stainless steel sponge kettle was charged with 5.5 L of distilled water and the temperature controlled at 40° C. The reactor contents were mixed as described in Example 5. To this reactor 427 mL of a 3.6M solution of ammonium sulfate and 100 mL of a solution containing 1.5 g sodium polystyrenesulfonate-70K MW (PSS) was added. Peristaltic pumps were used to simultaneously deliver a 3840 mL solution containing 3.1M silver nitrate at a rate of 225.0 mL/min, a 200 mL solution containing 2.9M ammonium sulfate at a rate of 117.1 mL/min and a 400 mL solution containing 1.5 g PSS at a rate of 23.3 mL/min causing precipitation of a white product. The reaction was held at 40° C. for 5 min. The final product was washed to a conductivity of <10 mS and a portion dried at ambient temperature for 24 h followed by further drying for 4 h at 85° C.

Preparation of Silver Sulfate Sample 6-B: Inventive with Potassium Iodate Additive

An eighteen-liter stainless steel sponge kettle was charged with 5.5 L of distilled water and the temperature controlled at 40° C. The reactor contents were mixed as described in Example 5. To this reactor 427 mL of a 3.6M solution of ammonium sulfate and 100 mL of a solution containing 1.5 g sodium polystyrenesulfonate-70K MW (PSS) was added. Peristaltic pumps were used to simultaneously deliver a 3840 mL solution containing 3.1M silver nitrate at a rate of 225.0 mL/min, a 2000 mL solution containing 2.9M ammonium sulfate at a rate of 117.1 mL/min and a 400 mL solution containing 1.5 g PSS at a rate of 23.3 mL/min causing precipitation of a white product. The reaction was held at 40° C. for 5 min after which a peristaltic pump delivered a 400 mL solution containing 6 g potassium iodate at a rate of 40.0 mL/min. The reaction was held at 40° C. for 5 min. The final product was washed to a conductivity of <10 mS and a portion dried at ambient temperature for 24 h followed by further drying for 4 h at 85° C.

PET composites containing 5.0 weight percent of the silver sulfate samples of Example 6 were prepared by the following procedure. A Leistritz twin-screw compounder with 10 zones was preheated to 265° C. and the screw speed was set to 200 rpm. Into the feed position at zone 1, was charged Voridian Poly(ethylene terephthalate) 7352 fed at a rate of 28.5 pounds per hour using a single screw pellet feeder. Following the melting of the polypropylene, silver sulfate powder (from Example 6) was fed at a rate of 1.5 pounds per hour into the feed position at zone 4 using a twin-screw side port feeder. All mixing, melting, and compounding occurred in ambient air. The resulting composite was extruded as 4 strands and quenched to room temperature (22° C.) using a flowing water bath. The resulting solid strands were fed into a multiblade chopper, generating composite pellets (approximately 1 cm by 2 cm in size).

A composite plaque was produced from pellets using a Carver Press preheated to 274° C. A sandwich was made by placing an aliquot of pellets between two polyimide polymer sheets. This sandwich was placed on the Carver Press platens, followed by bringing the platens together, melting the composite pellets, resulting in a plaque between the polyimide sheets. The sandwich was removed from the Carver Press, and the sandwich was quenched at room temperature (22° C.) between two metal plates. The polyimide sheets were peeled away, leaving a freestanding composite plaque. Quenched, neat PET is amorphous and clear, and therefore not well suited to characterization in a reflection calorimeter. To make opaque, the clear PET plaque was placed between 2 polyimide polymer sheets and heated to 160° C. by placing this sandwich between preheated platens for 30 seconds. Upon cooling the sample crystallized as an opaque PET plaque. Pure PET treated by this process will be referred to as Neat PET White.

The color of the composite plaques was quantified by the methods described in Example 1. Color metrics relative to Neat PET White are given in the table below:

| | Size Control | | | | | | | |
|---|---|---|---|---|---|---|---|---|
| | Additive | | Color Control Additive | | | Relative | | |
| Sample | | Amount | | Amount | Addition | Color Metrics | | |
| No. | Compound | (mol %) | Compound | (mol %) | Point | DL* | Da* | Db* |
| 6-A | PSS | 0.04 | none | — | — | −18.8 | 8.6 | 33.2 |
| Comp. | | | | | | | | |
| 6-B | PSS | 0.04 | potassium iodate | 0.47 | After | −10.8 | 1.5 | 8.6 |
| Inv. | | | | | silver | | | |

Comparison of the relative color metrics shown above indicates that the severe darkening (negative DL*) is reduced by about one half and the severe discoloration (positive Da* and Db*) is reduced dramatically for PET that is melt-processing with silver sulfate precipitated in the presence of the grain-size reducing additive sodium polystyrenesulfonate, when the potassium iodate additive of the invention is included in the silver sulfate precipitation reactor prior to the final washing and drying steps.

In summary, it has been observed that the problem of darkening and discoloration associated with melt-processed polymers (and in particular, polypropylene and PET) containing silver sulfate can be about an order of magnitude larger when the silver sulfate is precipitated in the presence of a grain-size reducing additive, such as an organo-sulfate or organo-sulfonate compound. It has been discovered that stabilizers comprising a bromate or iodate ion are surprisingly effective in reducing the darkening and discoloration. The stabilizers of the invention may be added to the polymers prior to compounding of the silver sulfate, or, preferably, the stabilizers are added at least in part to the silver sulfate precipitation reactor prior to the final drying step.

The invention has been described in detail with particular reference to certain preferred embodiments thereof, but it will be understood that variations and modifications can be effected within the spirit and scope of the invention.

1. A polymer composite comprising a melt-processed polymer compounded with a color stabilizer comprising a bromate or iodate ion, and a silver-based antimicrobial agent.

2. The composite of claim 1, wherein the melt-processed polymer comprises a polyolefin.

3. The composite of claim 2, wherein the polyolefin comprises polypropylene.

4. The composite of claim 1, wherein the melt-processed polymer comprises a polyester.

5. The composite of claim 4, wherein the polyester comprises polyethylene terephthalate.

6. The composite of claim 1, wherein the silver-based antimicrobial agent comprises silver sulfate.

7. The composite of claim 6, wherein silver sulfate is precipitated in the presence of a grain-size or grain-size distribution reducing additive.

8. The composite of claim 6, wherein the composite comprises at least 1 wt % of silver sulfate.

9. The composite of claim 7, wherein the grain-size or grain-size distribution reducing additive is an organo-sulfate or organo-sulfonate compound.

10. The composite of claim 7, wherein the grain-size or grain-size distribution reducing additive comprises a dodecylsulfate ion.

11. The composite of claim 7, wherein the grain-size or grain-size distribution reducing additive comprises a dodecylbenzenesulfonate ion.

12. The composite of claim 7, wherein the grain-size or grain-size distribution reducing additive comprises polystyrenesulfonate.

13. The composite of claim 1, wherein the composite comprises melt-processed polypropylene compounded with at least 0.1 wt % of silver sulfate, and wherein the presence of the color stabilizer results in lower calorimetric a* and b* values and a higher calorimetric L* value for the composite relative to those obtained for a corresponding melt-processed polypropylene compounded with the same wt % of silver sulfate in the absence of the color stabilizer.

14. The composite of claim 1, wherein the composite comprises melt-processed polyethylene terephthalate compounded with at least 0.1 wt % of silver sulfate, and wherein the presence of the color stabilizer results in lower colorimetric a* and b* values and a higher calorimetric L* value for the composite relative to those obtained for a corresponding melt-processed polyethylene terephthalate compounded with the same wt % of silver sulfate in the absence of the color stabilizer.

15. A process of preparing a composite of claim 1, comprising compounding the color stabilizer with the melt-processed polymer prior to or simultaneously with compounding of the silver-based antimicrobial agent.

16. A process according to claim 15, wherein the color stabilizer is added to the silver-based antimicrobial agent prior to compounding of the silver-based antimicrobial agent with the melt-processed polymer, and the color stabilizer is compounded with the melt-processed polymer simultaneously with compounding of the silver-based antimicrobial agent.

17. A process according to claim 16, wherein the silver-based antimicrobial agent is prepared by an aqueous precipitation process, and the color stabilizer is added to the silver-based antimicrobial agent during precipitation thereof.

18. A process according to claim 17, wherein the silver-based antimicrobial agent is precipitated at least in part by reaction of simultaneous introduction of a silver salt solution and an anion salt solution feed stream.

19. A process according to claim 17, wherein the silver-based antimicrobial agent is silver sulfate.

20. A process according to claim 19, wherein the silver sulfate is precipitated in the presence of a grain-size or grain-size distribution reducing additive distinct from the color stabilizer.

21. A process according to claim 20, wherein the grain-size or grain-size distribution reducing additive is an organo-sulfate or organo-sulfonate.

22. A process according to claim 21, wherein the grain-size or grain-size distribution reducing additive comprises a dodecylsulfate, dodecylbenzenesulfonate or polystyrenesulfonate ion.
